(19) United States
(12) Patent Application Publication
(10) Pub. No.: US 2009/0092252 A1
(43) Pub. Date: Apr. 9, 2009

(54) Method and System for Identifying and Managing Keys

(76) Inventors: Landon Curt Noll, Sunnyvale, CA (US); Robert Adrian Lockhart, Danville, CA (US)

Correspondence Address: FISH & RICHARDSON P.C., PO BOX 1022, MINNEAPOLIS, MN, 55440-1022, US

(21) Appl. No.: 12/102,853

(22) Filed: Apr. 14, 2008

Related U.S. Application Data
(60) Provisional application No. 60/923,497, filed on Apr. 12, 2007.
(60) Provisional application No. 60/926,203, filed on Apr. 24, 2007.

(51) Int. Cl. H04L 9/06

(52) U.S. Cl. 380/277

(57) ABSTRACT

A system and method for managing encryption keys, wherein one of more of they keys incorporates a disabled state, and wherein the system further incorporates a namespace.

### CLAIM OF PRIORITY

This application claims the benefit of priority under 35 U.S.C. § 119(e) to U.S. provisional application Ser. Nos. 60/926,203, filed Apr. 24, 2007, and 60/923,497, filed Apr. 12, 2007, both of which are incorporated herein by reference in their entirety.

### TECHNICAL FIELD

The technology described herein generally relates to systems and methods for managing encryption keys, and more particularly relates to useful states and indexing schemes for such keys.

### BACKGROUND

Over the past several years, malicious attacks against computer systems and electronic thefts of private information have skyrocketed. And each data compromise or exposure that lands in the headlines leaves companies wondering if they will be next—and how they can prevent such an event from happening in the first place.

To provide protection from these attacks, most companies have secured their systems and network from outsiders, implementing perimeter-based security strategies with firewalls and virtual private networks (VPNs) to ensure that external users without proper authorization cannot access sensitive data. But according to the CSI/FBI 2005 Computer Crime and Security Survey, internal threats are nearly as prevalent as outside threats. Of the 453 respondents, 56% had at least one incident within the past 12 months from an internal source (U.S. Department of Justice, http://www.usdoj.gov/criminal/cybercrime/FI2005.pdf.). The perimeter-based security solutions most companies depend on are powerless to stop these internal threats.

Acknowledging this gap—as well as the demands of increasing government and industry-driven regulations concerning data retention and privacy—some companies are looking beyond traditional perimeter-based security methods to secure data. (One example of an industry-driven initiative is the Payment Card Industry Data Security Standard (PCI DSS) in the financial industry.) They are focusing instead on securing the data resident on the storage media within their organizations (data at rest) and data moving between their systems on the network and storage devices (data in flight or data in transit). This is also known as storage security. With proper storage security, a company can ensure data integrity as well as mitigate the damage compromised or stolen data can have on its long-term corporate image and financial standing. Typically, storage security includes three components: authentication, access control, and encryption. Encryption is the process of scrambling of data to prevent unauthorized persons from reading it, and has two primary components: the encryption algorithm and the key.

For a given encryption algorithm, a key is generated or assigned based on the specific security requirements. In order to ensure that security is maintained for encryption operations, processes must be put into place that allow for complete control and security of the keys used to encrypt and decrypt the data.

Today, data encryption has become commonplace for electronic commerce, VPNs, and other data in flight systems. With the advent of new regulations and the recent press attention, data at rest is now seeing a surge in encryption requirements at the application, file, and media level.

Many encryption algorithms in use today were created by government agencies or standards bodies. Most recently, National Institute of Standards and Technology (NIST) selected the Advanced Encryption Standard (AES) based on an open request for proposal. Other cryptographic algorithms and standard test criteria have been established by NIST under the Federal Information Processing Standard (FIPS). FIPS is a set of requirements and recommended practices for securing data by U.S. government agencies (http://csrc.nist.gov).

Governments outside the United States may have specific testing criteria and it is a good practice to use a device that has been certified to meet the testing criteria of the country in which the encryption systems will be deployed.

### SUMMARY

The disclosure herein references one or more methods. It is to be understood that those methods are performed by one or more computer-based systems (comprising, e.g., one or more processors), and that instructions for carrying out those methods are stored on one or more items of physical media, such as read-only memory (ROM), random-access memory (RAM), flash drives, CD-ROMs, and the like.

A method of controlling use of an encryption key, wherein the encryption key resides in one or more key management servers in a key management system, the method comprising: disabling the encryption key, wherein the disabling comprises: deleting the encryption key from all cryptographic units; and isolating the encryption key within the key management servers in the key management system, wherein isolating the encryption key comprises barring all access to the disabled encryption key.

The method, further comprising: updating metadata of the disabled encryption key to indicate a new state.

The method, further comprising: determining whether the encryption key can be returned to a usable state, wherein the determining is performed by a user with appropriate credentials; and if the encryption key can be activated, activating the encryption key for use by the cryptographic units by restoring the key to a usable state.

The method, wherein a user with appropriate credentials comprises a key administrator or manager.

The method, wherein a usable state comprises any state higher than the disabled state.

The method, wherein a user with appropriate credentials is authorized to determine whether a disabled key can be activated with respect to a security policy associated with the encryption key.

The method, further comprising: if the encryption key was activated, updating the metadata of the encryption key to indicate its new state.

The method, further comprising: splitting the disabled key into two or more component shares, and storing each component share, wherein rights to each component share are given to an administrator or manager, wherein no administrator or manager has rights to more than one component share.

The method, further comprising: determining whether the encryption key can be returned to a usable state, wherein the determining is performed by a user with appropriate credentials; and restoring the encryption key to a usable state, wherein restoring the encryption key comprises restoring two or more of the component shares.

The disclosure further includes a method of setting a state of an encryption key, wherein the encryption key resides in one or more key management servers in a key management system, the method comprising: setting the state of the encryption key to a state indicating that the encryption key has been disabled.

The method, further comprising: determining whether the encryption key can be activated, wherein the determining is performed by a user with appropriate credentials; and if the encryption key can be activated, setting the state of the key to a usable state.

The method, wherein a user with appropriate credentials comprises a key administrator or manager.

The method, wherein a usable state comprises any state higher than the disabled state.

The method, wherein a user with appropriate credentials is authorized to determine whether a disabled key can be activated with respect to a security policy associated with the encryption key.

The method, further comprising: updating the metadata of the disabled encryption key to indicate its new state.

The disclosure further includes a method of identifying an object within a key management system, the method comprising: creating a GUID for the object, wherein the GUID is represented by a URI, the URI comprising a prefix, a realm element, an object element, and a path element;

mapping the URI to one or more key management servers in the key management system; and storing the object on the one or more key management servers in the key management system.

The method, wherein the prefix is “km”, or “kms”.

The method, wherein the realm element comprises a Domain Name Service domain name.

The method, wherein the realm element comprises a name of a zone of authority within the key management system.

The method, wherein the object element comprises an object space including any key under the control of the key management system.

The method, wherein the object space is named “key”.

The method, wherein the object element comprises an object space including any key management policy.

The method, wherein the object space is named “policy”.

The method, wherein the object element comprises an object space including any key management client.

The method, wherein the object space is named “client”.

The method, wherein the object element comprises an object space including any key management group.

The method, wherein the object space is named “group”.

The method, wherein the object element comprises an object space including any key management pool.

The method, wherein the object space is named “pool”.

The method, wherein the object element comprises an object space including any key management set.

The method, wherein the object space is named “set”.

The method, wherein the object element comprises an object space including any key management log.

The method, wherein the object space is named “log”.

The method, wherein the object element comprises an object space including any key management session.

The method of claim 33, wherein the object space is named “session”.

The method, wherein the object element comprises an object space reserved for the DNS domain.

The method, wherein the object space is named “.domain”.

The method, wherein the path element comprises a multi-element path.

The method, wherein the multi-element path defines a common default access control for the object.

The method, wherein mapping comprises using KMSS.

The method, wherein mapping comprises using KMCS.

The method, further comprising: storing the object on one or more cryptographic units in the key management system.

The method, further comprising: storing the object on one or more KM Clients in the key management system.

The method, further comprising: distributing the object to one or more KM Clients in the key management system.

A method of retrieving an object within a key management system, the method comprising: receiving a URI for the object;

mapping the URI to one or more key management servers in the key management system; and retrieving the object from one of the one or more key management servers in the key management system.

The method, wherein mapping comprises using KMSS.

The method, wherein mapping comprises using KMCS.

The details of one or more embodiments of the technology are set forth in the accompanying drawings and the description below. Other features, objects, and advantages of the technology will be apparent from the description and drawings, and from the claims.

### BRIEF DESCRIPTION OF DRAWINGS

FIG. 1 represents a hierarchy of encryption keys.

FIG. 2 illustrates a lifecycle of an encryption key for data at rest, from creation to deletion.

FIG. 3 is a schematic of an exemplary Key Management System architecture.

FIG. 4 illustrates an operation of a centralized key management system.

FIG. 5 illustrates an operation of a distributed key management system.

FIG. 6 illustrates an operation of a hybrid key management system.

FIG. 7 represents an embodiment of a disk array with disk-array-specific keys.

FIG. 8 represents different possible ways of associating one or more keys with one or more disk devices.

FIG. 9 is a representation of key states and certain transitions between those key states.

FIG. 10 is a schematic of an exemplary architecture where a host is the Key Management Client (KM Client), and all storage is either internal to or directly attached to the host.

FIG. 11 is a schematic of an exemplary architecture where any of several secondary storage devices belonging to a host may be a KM Client.

FIG. 12 is a schematic of an exemplary architecture where any of several primary storage devices (using both SAN and NAS solutions for host to disk connectivity) may be a KM Client.

FIG. 13 illustrates a six-phase lifecycle for an encryption key.

### DETAILED DESCRIPTION

### Introduction

Service-based systems have several advantages over central control based systems. It is easier to incrementally grow a service by adding products from vendors that best meet an organization's requirements. Central control models tend to lock organizations into the first product line they select. Even if that first product perfectly matches the requirements of the organization at selection time, it may not be the best match later. The methods and apparatus herein for managing encryption keys are particularly suited for installation and operation within a service-based system, though may also be applicable to control-based systems.

Organizational requirements change over time. With a service-based system, an organization with a new set of requirements may add any product line that best fulfils its new requirements without endangering its existing infrastructure. Organizations can add to a service-based system without requiring massive upgrades or wholesale swaps of software and equipment.

Where possible, it is assumed that key management services will take full advantage of existing standards, e.g., communication and authentication standards, however, the technology is not limited to use of the standards described herein, nor is the technology limited to the use of standards existing at the time of the filing date of this application.

Exemplary embodiments of a Key Management Services (KMS) model are largely based on data at rest use cases. Although embodiments described herein focus on data at rest, the technology is not limited to data at rest. Furthermore, the KMS architecture presented herein is not limited to only the data at rest use cases described. The system presented is flexible enough to cover key management requirements for data at rest irrespective of data type.

### Selected Definitions

“Data in flight” refers to any data that is moving from one place to another. Corporations have embraced encryption to secure all varieties of data in flight. An example is financial data traversing the public network using a VPN for secure transactions between businesses.

“Data at rest” is data that sits on media. Media can include disk, tape, optical, or any other electronic-based media. However, when data on tape media is transported from a tape library to an offsite storage facility, it should be considered data in flight, not data at rest because although it moves much more slowly than data within a computer network, it still moves from one place to another, even if the destination is a physical warehouse.

“Authentication” ensures that users and systems are who they say they are. Several standards and protocols for authenticating users on a network are widely implemented in companies around the globe, including Remote Access Dial-in User Security (RADIUS) and Challenge Handshake Authentication Protocol (CHAP). New storage-specific methods and standards, such as Diffie-Hellman CHAP, are now emerging that enable organizations to add authentication to the storage infrastructure. In other words, they allow authentication of users or devices to occur before information can be stored.

“Access control” limits the ability of the user or system to access data. On a network, users can only view data allowed by router access control lists and directory services that control access. Within the storage infrastructure, which servers have access to what data is controlled by zoning and (Logical Unit Number) LUN mapping.

“Encryption” is the process of scrambling of data to prevent unauthorized persons from reading it, and has two primary components: the encryption algorithm and the key. While encryption algorithms can be implemented using various standards, most systems use specific algorithms for specific operations, such as Triple Data Encryption Standard (3DES) for encrypting data at rest and Advanced Encryption Standard (AES) for encrypting data in flight.

“Symmetric keys” are private keys that are shared between two or more systems to encrypt and decrypt data. A symmetric private key used to encrypt and decrypt should not be exposed under any circumstance. Symmetric keys are the recommended approach for data at rest. There are currently two symmetric key standards being developed for data at rest. The first standard, for disk, is being created by IEEE P1619. The second standard, focusing on tape media, is being developed by IEEE P1619.1.

“Asymmetric keys” consist of a public and private key pair. The private, or secret, key is similar in concept to a symmetric private key with the exception that it is not shared with other parties. The public key, on the other hand, is widely distributed and shared. Revealing the public key does not reveal or compromise the corresponding private key. When using asymmetric keys for encryption, the public key is used to encrypt the data and the private key is used to decrypt the data. Thus, when sharing information with other organizations or business partners, it can be useful to implement asymmetric keys.

A “key management system” is one that combines the devices, and operations useful to create, maintain, and control keys, with or without user input. The system can contain operational practices that are implemented in order to make it work effectively. Some of the common components used in a key management system include: key generators; smartcards, tokens, or even floppy disks; electronic transport; encryption devices; key archive systems; key backup files or devices; logging systems or devices; and operational practices, such as alerting and auditing.

### Data Formats

Data formats covered in this application include Disk, Tape, File, Database, and Objects. Disk embodiments include, but are not limited to, block-based disk storage and direct-attached or SAN (locally-attached) storage (e.g., disk, CDROM, flash disk). Tape embodiments include, but are not limited to, Linear Tape-Open (LTO) and Virtual Tape. File embodiments include, but are not limited to, documents or other files that exist in a file system used by an operating system. Database embodiments include, but are not limited to, any data representation that consists of tables of columns, rows, records and/or fields, relational databases, hierarchical databases, networked databases, object databases, and post-relational databases. Application data embodiments include, but are not limited to, any data encrypted and decrypted for use by a specific application regardless of data storage location. Object embodiments include, but are not limited to, any data at rest which includes any of the types listed above as well as data subcomponents found in the above.

Additional data types may be defined at a later date and time that have different use cases that should be taken into consideration when developing a KMS standard. When possible, all data types will be referred to as encrypted objects regardless of media or data type.

### Storage Security and Encryption

Typical characteristics of a key management system in a storage environment, consistent with use and implementation of the technology described herein, can include the following.

A starting point of any storage security exercise is to understand the threats. Best practices dictate that companies perform risk assessments. Then, using a combination of the risk assessment and associated remedies along with costs, the company can determine the best storage security approach for its specific needs.

Typically, whenever data leaves a facility, it should be encrypted. Components within this model that need to be considered include the data network, laptops, desktops, servers, applications, tape media, and even disk array media.

To protect media that leaves the company's site, several options exist, including media wiping, media destruction, and encryption. Of the three options, each has an associated cost and, based on the sensitivity of the data, one option may be preferred over the others. In the case of encryption, all of the cost is either up front or over the life of the system. Media wiping and media destruction costs are added to the end-of-life cost.

Data Encryption may be carried out by any suitable encryption algorithm, including symmetric, asymmetric, and public/private, and may be applied to data in flight, as well as data at rest.

An additional consideration for data at rest and data in flight is the ability to ensure that the encrypted data has not been altered or tampered with (also referred to as cryptographic authentication). Message digests, or secure hashes, consist of a fixed-length bit string that can be used to verify the validity of the data, and are highly recommended for both data at rest and in flight. By authenticating the data prior to decryption, a user knows that the data is correct based on the secure hash.

There are various mechanisms for calculating secure hash. While the most common mechanisms are MD5 and SHA1, both have known weaknesses, and stronger hashes—such as SHA256, SHA384 and SHA512—are recommended. Alternatively, the Keyed-Hash Message Authentication (HMAC) with a stronger hash is also a good solution.

Digital signatures are the electronic analog to signing a name on a piece of paper. The signature validation equivalent to a notary may be performed by an Internet-based Certificate Authority (CA), an organization-based authority, or the user can provide a self-signature. For key management systems, using a CA is a recommended approach to ensure authentication prior to exchanging any keys.

There are typically two types of keys. The first type is a symmetric key, which is a single key used to both decrypt and encrypt the data. The second type of key is an asymmetric key, which uses two different keys to provide encryption and decryption operations. All of these key types may be managed by the technology described herein.

No matter which type of key is used, best practices suggest that a company creates a hierarchy of keys for security purposes. In an exemplary embodiment, a key hierarchy consists of at least two levels of keys, consisting of the data encryption key and a key encryption key (KEK), which is used to store the key in an encrypted form. It is also considered a best practice to authenticate the keys using a Key Message Authentication Code (KMAC), which can consist of a secure hash or HMAC signature.

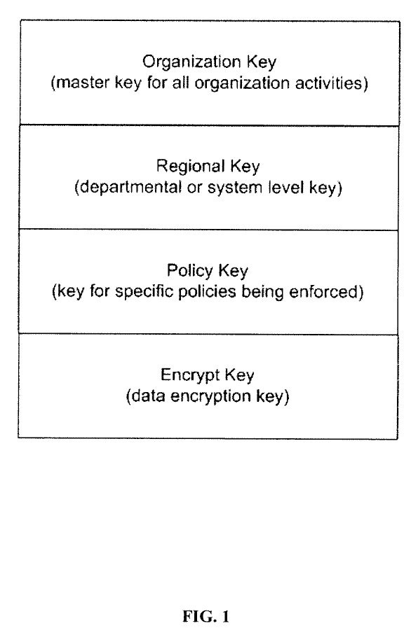

By creating a hierarchy of keys, an organization can also provide better access to any or all-keying material. The deeper the hierarchy, the more robust the key management system required for operations. FIG. 1 presents an exemplary hierarchy of keys.

In a proper key hierarchy, a KEK will also have a KMAC that is created simultaneously, so that encrypt keys can also be cryptographically authenticated.

In FIG. 1, the upper-most key would only be used for encrypting and signing the regional keys below it, making it highly protected and rarely used. This would aid in a worst-case scenario where all regional keys have been destroyed but must be recovered to resume operations.

In an embodiment in accordance with FIG. 1, the Organization Key would be used for encrypting the regional keys below it and the Regional Keys would be used to encrypt the Policy Keys below them. The Organization Key should never become known to another except to sign and encrypt a regional key. If the Organization Key is exported for backup purposes, it should be done using a split knowledge system. This is important in the event all regional keys have been destroyed and the keys below must be recovered to resume operations.

Storage security benefits from use of a key management system. The operational aspect of any key management system is probably the most overlooked aspect of the system as a whole. Processes should be repeatable, replicable, and secure to meet the requirements of key management in today's organizations. Independent of the key management system that is used, every key has a “shelf life” that should be monitored, maintained, and controlled.

### Key Lifecycle Management

From the moment it is generated or entered until it is deleted, managing the lifecycle of the key is important to ensure it is never exposed or used inappropriately. Organizations should take care to ensure the security of keys, even restricting them from inappropriate use by administrators or other authorized users.

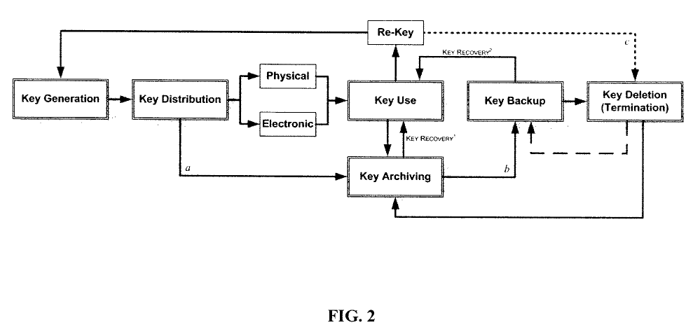

FIG. 2 illustrates a lifecycle of data at rest encryption key, from creation to deletion. Each phase within the key lifecycle as shown—along with an associated component of a key management system—is described in detail in the following sections, using FIG. 2 as a reference.

Key Generation: Keys can be created using either manual or automatic generation. The prevailing wisdom, however, is that the less human intervention, the more secure is a key. In addition, unique keys generated on a per-use basis (e.g., a unique key generated for each tape) provides greater security than a single key generated to encrypt data on all tapes in the enterprise.

One method of key creation involves manually generating keys by entering them (e.g., via a keyboard, keypad, or touch-screen) into the system that will use the keys to encrypt or decrypt data. However, typing keys into a system is not a recommended key generation method unless the system is isolated from all other connectivity and the keyboard used to type the key has no memory or network connectivity. This prevents key loggers or memory mapping utilities from capturing the keys as they are entered.

Another key generation method is automated, and involves using a random bit generator (RBG), also known as a random number generator (RNG). Random bit generators in use today fall into one of two categories: deterministic (DRBG) and non-deterministic (NRBG). A DRBG is also referred to as a Pseudo-Random Number Generator (PRNG). A NRBG may also be referred to as a True Random Number Generator (TRNG).

There are several recommended types of DRBG that have been defined by various standards bodies and certified by various government and other agencies. To date, no certified or accepted NRBG exists due to a lack of a standard verification process. Until one is developed, it is good practice to use a DRBG (PRNG) that has been certified by an appropriate agency.

An automated key generator can be a standalone device or included in a piece of cryptographic equipment. The generator must be contained in a secure hardware component, rather than in software running on an off-the-shelf system.

Key Distribution: Once created, a key should be distributed to all the users that will encrypt and/or decrypt data. Again, there are several options to performing this action. The first, and preferred, method is electronic key distribution. The second method is manual distribution via smartcards. No matter which method is used in an ongoing manner, the initial sharing of a key or certificate is typically conducted manually, so that a secure communication can be initiated to begin sharing keys electronically.

At the time it is distributed, it is a good idea to send the key directly to an archive and, therefore, a backup facility (see FIG. 2, Connection a). If the key user has the ability to forward it to the archive, he or she should do so before using the key to encrypt data.

Sneaker Net and Other Manual Exchange Mechanisms: When using manual key exchange methods, the recommended practice for keys used for data or keys that protect other keys is to use “split knowledge systems.” These systems, such as M of N (also referred to as K of N) systems, split the key into pieces among multiple individuals. Normal practices of split knowledge systems break the keys into component shares to be given to five different users and then require a minimum of two of these users to be present to re-establish the key (see, e.g., A. Shamir, “How to Share a Secret”).

This practice is recommended for any manual key exchange when a higher level key or KEK is not present on the remote system. It is also a good practice for top-level key recovery in the event of disaster.

No matter how a key is distributed, it should be encrypted at least once using a strong method or split into multiple shares using split knowledge trust.

Network-based Key Exchanges: There are several considerations before using network-based key exchange mechanisms, including:
How is the link secured?
Are the keys sent across the link encrypted prior to transmission (e.g., doubly encrypted)?
Can complete security be ensured?

Prior to exchanging keys across a network connection, the end-points should authenticate with each other using a strong network authentication mechanism, such as Password Authentication Protocol (PAP) or Challenge Handshake Authentication Protocol (CHAP).

Many definitions exist for key exchange and should be thoroughly researched to ensure the proper technique is used for the environment. An example of a standards-based key exchange mechanism includes Internet Key Exchange version 2(IKEv2).

When implementing storage security (e.g., using keys in data storage networks), the first step is to determine which encryption method to use. Typically, in a data at rest situation, symmetric keys are the solution-of-choice, due to performance and footprint issues. Most enterprises today use AES, as it is the strongest form of encryption available.

Once an encryption algorithm is chosen, then the enterprise determines the granularity of the key. In other words, at which level—disk, directory level, or individual file—to encrypt the data. Key granularity is typically dependent on the sensitivity of the data and its criticality to the organization. The granularity of the keys may also impact re-keying requirements.

Re-keying in a Storage Environment: Re-keying is an operation where a new key is used to encrypt and decrypt data. For data in flight, re-keying methods exist that do not impact operations. For data at rest, on the other hand, re-keying requires planning to minimize the operational impact.

Another consideration is that if the system re-key was a result of potential exposure of the key or data, the old key should be marked for deletion. Once the re-key operation is completed, as shown in FIG. 2 connection c, the key should be deleted either automatically or as part of an operational process.

There are situations where re-keying data at rest must be planned. One such case is tape media, where re-keying can require a large amount of time. Re-keying tape media should be planned when media or equipment is rotated out due to age to ensure recovery.

In addition, companies should consider rotating media for backup and archive operations as well, because it provides a good opportunity to perform re-keying operations of the data at rest and can potentially reduce or maintain offsite storage costs through media consolidation, thereby reducing cost of ownership.

Because tape can be kept for many years, a good archiving mechanism is imperative to ensure the recoverability of the key when the media is recovered, replaced, or expired.

A final consideration that can alleviate some of the concerns of constant re-key operations is to use granular keys such that at least one key exists for each type of media (e.g., tape, LUN, file, field, object, mail).

Key Archiving: Key archiving provides the ability to quickly recover a key. Typically, the key archiving process is automated, but it can be done manually if required. Key archives are typically implemented within some form of tamper-proof hardware to ensure key security. Four examples of hardware-based key archiving solutions include:

Secure Memory: Secure memory is specific memory within a specialized platform that can be secured from tampering or alteration. It is rare to find this in operational use and usually comes as a subcomponent of a Hardware Security Module (HSM) or a secure hardware appliance.

Hardware Security Modules: A Hardware Security Module, or HSM, is a module within systems that provides security for keys or other security related items. For key management it provides a secure location for key storage and can provide protection of keys from the operating system if the keys are used elsewhere.

An ideal key management system has an HSM that provides secure communications so that keys are never revealed to inappropriate users, operating systems or applications. The system that contains the HSM should have limited access to the HSM and if possible the HSM should have its own management interfaces outside of the system it is in.

Secure Hardware Appliances: As storage security creates more demand for encryption, the amount of disk space needed for the long-term storage of keys will increase as well. Secure hardware appliances are hardware platforms completely dedicated to key archiving, providing the storage space needed for large implementations and regulatory compliance.

Purpose-built encryption system vendors are beginning to add key management functionality within their offerings, due to the long-term retention requirements of these solutions. Such encryption systems are thereby self-contained. While most offerings provide complete key archiving functionality, some solutions require external backup and recovery as well as manual key migration.

Even if self-contained systems contain their own archive there should be either a second archive or backup system available.

Key Recovery: Key recovery from an archive in a data at rest scenario is important, particularly when encrypted data must be stored for several years due to regulatory or other requirements. An archive should be capable of retaining keys for long periods of time and providing those keys when needed.

If the organization chooses to implement automated key recovery, the process should be tested at regular intervals to ensure that it meets the organization's needs, no matter in which type of archive the keys are stored.

Key Backup and Recovery: Understanding the difference between key archiving and key backup is important, because the two processes serve very different functions. Key archiving stores the keys but makes them easily and readily available for decryption or encryption of data. In contrast, key backup is the practice of securely backing-up keys and storing them in the event of a disaster. Ensuring control of key backup mechanisms is extremely important to key security and integrity. A misplaced backup file is useful to no one, while a backup file with weak security is an accident waiting to happen.

To improve the control of key backups, implementing key escrow at a remote, organization-owned secure facility or at a certified/bonded third-party location to maintain the backup of keys is recommended. However, this does not mean that a key backup is not part of an automated key management system. The key backup may be a secondary archive that receives the keys from multiple archives. The only caveat is that the backup should be placed in a separate location, separate from the archive itself.

As shown in FIG. 2, Connection b, it is important to backup the archive based on normal backup practices, such as weekly full and daily incremental or differential backups.

Key Escrow: Key escrow is the practice of maintaining keys at a secure third-party site, which enables keys to be retrieved as long as the requester has the appropriate access, authority, and credentials. Key escrow service is becoming more commonplace as longer-term key management becomes an operational requirement.

Organizations should ensure that the key escrow company they choose can meet all key storage and retrieval requirements. It is always a good practice to test these capabilities on a regular basis or as part of a disaster recovery plan.

Key Deletion: A significant challenge to any key management system is ensuring that, once a key has been exposed or retired, or the data media on which it was stored has been lost, stolen, or replaced, it can be deleted so that it cannot be recovered by any malicious party.

A good key management system will have both automated and manual processes and will ensure that all copies of a key are deleted from all devices, archives, and backups.

Automated delete functionality, while alleviating significant operational overhead, ideally implements appropriate processes to ensure that deletions function as required. While this does consume operational cycles, it does not take nearly as many as manual key deletion, and it ensures that the highest level of security is maintained.

While keeping a key beyond deletion is not recommended, there is the potential a key will be needed to recover data on a previously lost or misplaced tape, e.g., for a Federal audit. In this case, the key should exist in one or two secure archives and should not be recoverable unless split knowledge mechanisms are employed.

Key Logging: In the foregoing, key management has been described from a lifecycle perspective. However, a good key management system will also track every key, logging which users have used it, and when and what actions the users conducted with the key. This is called key logging.

From the time a key is generated until it is finally deleted, all events related to that key should be logged in one or more types of logs. Then, depending on the nature of the key, the data it protects, and who must be notified of a key event, one or more type of alert may be required, including: a console log, a SNMP trap, a system log, a secure audit log, or an email alert. A console log uses a terminal server with a large buffer to protect the log against loss of connectivity with the key management system. A SNMP trap sends an alert to a standards-based network or system management platform that can provide automation for key management activities. A system log receives alerts that can be input into correlation engines or SNMP-based network management systems to generate automated actions or operational procedures. A secure audit log provides a searchable audit mechanism for use with forensic activities or independent audit activities. Secure audit logs contain only security-related functions and information. An email alert sends an email notification when a specific action is required by a particular individual or group.

Alerts based on events can be used to correlate potential misuse of keys or systems, or potentially malicious activities, as well the occasional human error. Automating the alert process is important, simplifying the day-to-day operations of the key management system and ensuring that the appropriate individuals are notified in a timely fashion when an event occurs.

The table below illustrates five common types of alerts and the logging tools to which these alerts are assigned.

| | Console | SNMP | System | Secure | E-mail |
|---|---|---|---|---|---|
| Key Function | Log | Trap | Log | Audit Log | Alert |
| Key Creation | | | | ✓ | |
| Key Export | | | ✓ | ✓ | |
| Key Deletion | | ✓ | ✓ | ✓ | |
| Sensitive Data | ✓ | ✓ | ✓ | ✓ | |
| Key Export | | | | | |
| Enterprise Key | ✓ | ✓ | ✓ | ✓ | ✓ |
| Change | | | | | |

Secure Audit Logs: Secure audit logs are logs that exist on systems with limited access granted to users. Most access is provided either via a browser or command line interface. Secure audit logs capture every event that occurs for each key in the key management system, including creation, distribution, use, re-keying, archive location, backup (both internal and external), and deletion.

While a secure audit log behaves similarly to a traditional system log, it provides a better tracking mechanism, because it also includes additional security functions, such as access control and digital signing for events. This enables the correlation of time and events in the event of an audit or forensic activity to determine the source and resolution for a problem.

A secure audit log should be reserved for security functions and have only two roles. First, it should enable an administrator to do basic system setup and control while not providing access to the logs themselves. Second, it should have an auditor that can search, filter, and comment on specific events.

In addition, a secure audit log should provide services not included in traditional security devices, such as secure time stamps, message authentication, and digital signing of events. Other functions usually found in system logs, such as event deletion, modification, or manual entry, should not be allowed on a secure audit log.

When a secure audit log is in the form of a secured appliance, the appliance may be used for other functions, including key archive, backup, and policy management. However, the IT organization should evaluate each function individually to ensure that it meets both the security and operational requirements of the organization.

There should typically be at least two secure audit logs in separate locations to help alleviate the potential for lost communications and/or logged events from devices. Lastly, there should be a basic secure audit log function built into any device that uses or maintains keys.

### Key Management Overview

In an ideal Key Management System, key management is an open universal service. The owner of a key has the ability to share that key with any entity of their choice. Core key management is based on an open standard and freely available technologies. Any key management client that communicates with a key management server is able to receive the same core key management service. Owners of cryptographic data are able to organize, share, and maintain their cryptographic data as they pleased.

One aspect of a Key Management System is a service-based KMS. A Key Management (KM) Server is a provider of Key Management Service (KMS). In the KMS, multiple KM Servers provide their service throughout a network. (Domain Name Service (DNS) is an example of a widely deployed service-based architecture.) A KM Client is a consumer of KMS.

An objective of the present technology is to utilize a media device-independent protocol, thus minimizing the need for the KM Server to have knowledge of the media. Another objective is to facilitate auditing of KM Server and KM Client activity.

Another objective is to facilitate Key Management Policy (KMP). The KMP is typically established by the KM Officer and maintained by the KMS. Most KMPs are set by the KM Server and enforced by the KM Client; some KMPs may be both set and enforced by the KM Server, and some KMPs may be set by the KM Server and jointly enforced by the KM Server and the KM Client.

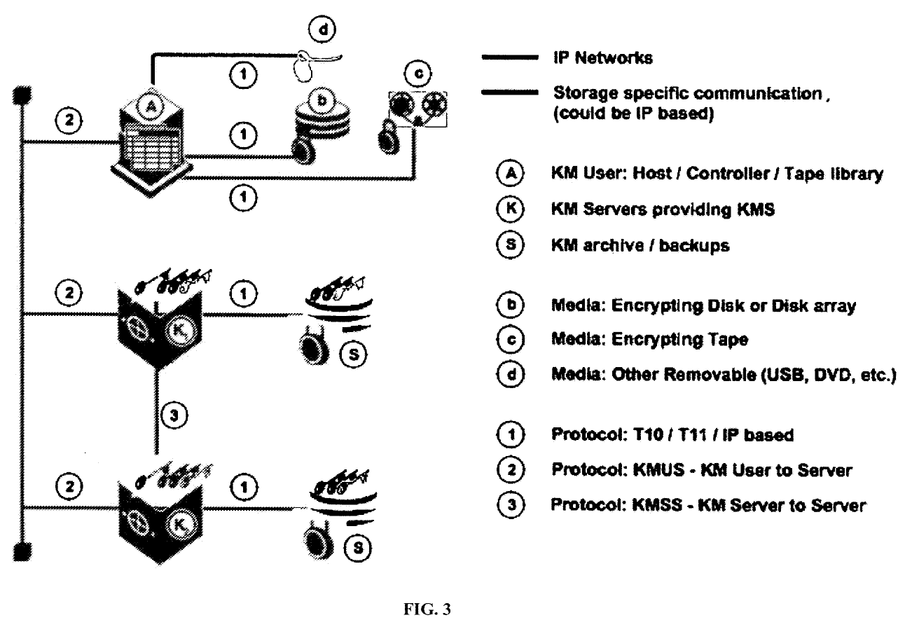

FIG. 3 is a schematic of an exemplary architecture including a host connected to various types of storage media, KM Servers with associated backups, and basic illustrations of KM Client to KM Server (KMCS) and KM Server to KM Server (KMSS) communication. Keys are generated by the KM Client (usually via the Cryptographic Unit (CU)) or by the KM Server on request of the KM Client. In order for the KMS to provide high availability service, the KM Servers may be clustered, and replication may be performed to local and/or remote KM Servers.

In FIG. 3, the KMCS and KMSS communications are sent over encrypted links (e.g., XML over TLS or SSL, such as HTTPS). The KM Client link to media may or may not be encrypted. If there is a CU in the KM Client and the media device, then encrypted T10-, T11-, or IP-based encryption may be used.

KMCS and KMSS have language-independent APIs. The KMCS API enables a KM Client to use KMS by facilitating KMS actions (e.g., “generate key”, “get key”, “store key”, “create KMS log entry”). The API also provides a flexible key generation KMP; the API can help the KM Client to implement key generation KMP.

KMCS key values are encrypted between the KM Server & KM Client. In an exemplary embodiment, KMCS usually sends XML over TLS protected links. The KMCS API provides decrypted key values to the KM Client; keys may be encrypted before being sent over the encrypted link and optionally decrypted by the KMCS API.

In one embodiment, a KMS can provide for KM user sessions. The KM Client Session model enables KM Servers to support multiple concurrent KM Clients. The KM Session is state-based, and the KM Servers keep a separate state for each KM Client. This enables KM Clients to issue concurrent KMS requests without waiting for replies to previous requests. KM Client sessions begin via a login to a KM Server (login sessions may persist across multiple TLS connections). Upon login, the KM Client and the KM Server exchange information for capability negotiation, policy notification, session information, etc. Sessions may be terminated by either the KM Client or the KM Server; sessions are also subject to time limits and API logout.

A KMS can further provide for KM Client Roles. Various administrator roles should be present for interoperability to exist between various key management offerings. These roles include at a minimum, the following classes of user roles for enterprise key management to function appropriately: Administrator, Security Officer, Policy Administrator, Auditor, Recovery Officer, Key Directory Manager. The listed user roles provide a base level of user rights that could be shared across multiple KM Servers, and, potentially, intelligent KM Clients. Additional roles or sub-roles may exist depending on the granularity required in a specific key management system, but there should be defined a minimum of specific types that can be agreed on by all devices.

The Administrator (KM_Admin) is responsible for network administration, alert & event management, user creation (no role assignment), and non-security related day to day operations. The Security Officer (KM_Officer) is responsible for assigning roles, system level security configuration, setup of recovery of top level keys, and key repository recovery. The Policy Administrator (KM_Policy) is responsible for creating global security policies to be applied to key directories and creating user policies for single or two person controls. The Auditor (KM_Audit) is responsible for accessing all log information from both security and generic event logs. The Recovery Officer (KM_Recover) is one of multiple persons responsible for recovering top level keys when using split knowledge or multi-person key material control. The Key Directory Manager (Key_Dir_Mgr) is a user who manages hierarchies of keys within a specific department or organization, or a user with security responsibilities for a set of devices within the KMS environment.

Additional granularity of control should be up to individual vendors as long as those users can be mapped to a generic role if required.

One KM Example provides for a KM Client in a RAID Controller, as follows. Initially, a KM Officer enrolls a KM Client in the KMS, and the KM Client's KMP is set by a KM Directory Manager. Thereafter, when the KM Client wishes to use KMS, the KM Client follows these general steps: (1) KM Client locates a KM Server in the KMS; (2) KM Client performs login to KM Server via the API; (3) KM Client detects new disk media; (4) KM Client issues a KMS request for an encryption key via KMCS API; (5) KM Server receives KM Client request and responds; and (6) KM Client uses the key value for new disk & log events.

Another KM Example provides for a KM Client controlling a removable media device for a backup application. Initially, a KM Officer enrolls a KM Client in the KMS, and the KM Client's KMP is set by a KM Directory Manager. Thereafter, when the KM Client wishes to use KMS, the KM Client follows these general steps: (1) KM Client locates a KM Server in the KMS; (2) KM Client performs login to KM Server via the API; (3) the backup application notifies the KM Client to load storage media; (4) KM Client issues a KMS request for an encryption key via KMCS API; (5) KM Server receives KM Client request and responds; and (6) KM Client uses the key value for new disk & log events.

### Globally Unique IDs and URI Name Space

In one Key Management System, one or more of several advantages exist: (1) customers are able to select their own key organizational model and organize their own keys; (2) both simple (flat) and complex (hierarchical) key organization models are supported; (3) vendor extensions are supported; (4) reserved space is available for future standard extensions; and (5) a Globally Unique ID (GUID) is created for each key in the Key Management System.

The goal of enabling system support for key GUIDs can be accomplished by means of a Universal Resource Identifier (URI)-based name space specifically for keys; in such a case, it can be said that a KM GUID is a fully qualified KMS URI in canonical form.

Format: In one embodiment, the URI namespace has four attributes and can be represented as kms://realm/object/path. The kms prefix identifies and distinguishes the KMS URI namespace. The realm element is the DNS domain name and a zone of KMS authority; realm domains are unique. The object element identifies an object namespace within the realm; object namespaces are unique within a realm. The path element is a unique element within an object space under a realm. Listed below are several KMS URI examples:
a simple key GUID—kms://example.org/key/keyid1
a key GUID under the vault key directory—kms://bigbank.example.org/key/vault/account_{—}12345
a GUID of a KMS user of isp.example.com—kms://isp.example.net/user/tape_vault_{—}1
a GUID of a policy that prohibits further encryption with a key—kms://finance.mycorp.example.biz/policy/decrypt_only

By definition, a KMS URI identifies an object under key management. A KMS URI is typically not a physical location, but is a GUID. A KMS URI does not necessarily identify a specific KM Server, because all copies of a replicated key have the same URI. Finally, in an exemplary embodiment, a KMS URI cannot be and never needs to be changed or renamed, because metadata can be copied from one URI to another.

Although a DNS domain may be an element of a KMS URI, the KMS URI model neither implies nor requires a web model; a KMS URI need not be a Uniform Resource Locator (URL). The KMS URI model does not require the use of either a web server or a web browser.

The realm element of a KMS URI can be a combination of the DNS domain name and a zone of KMS authority; thus, a realm indicates the zone of KMS authority.

Only the owner of a domain may create objects under the corresponding KMS realm. Taking, for example, the URI kms://example.org/key/vault/account_{—}12345, only KM Servers under example.org may create this URI. The URI may be found in KM Servers outside of example.org in certain situations, wherein the key associated with the URI was created by a KM Server in the example.org realm, and the key was exported to a non-example.org KM Server.

In processing a KMS URI, KM Servers use KMSS to map a URI to one or more KM Servers; KM Servers likewise also use KMSS to manage the {Server,URI,data} map.

TLS is recommended but not required for KMSS and KMCS. Both KMSS and KMCS should reserve their own respective ports so as to avoid collision with other network transmissions.

In an exemplary embodiment, standard KMS URI object spaces include: key, policy, client, group, pool, set, log, session, and domain.

The key object space includes any key under KMS control. Within the example URI kms://realm.domain/key/directory/keyid, the key directory is the entire path between the /key element and the final /keyid (note: / is the default key directory). Key directories define a common default access control for keys. KMS key URIs are key GUIDs; within a key directory, keyid is unique. The key object holds key value and key metadata.

The policy object space includes any KMP name (note: any KMS object can have zero or more associated KMPs). The policy object holds metadata needed to enforce the KMP. KMS objects reference a KMP via its URI. Within the example URI kms://realm.domain/policy/policy_name, policy_name can be a multi-element path, so as to define access control to the KMP (e.g., kms://realm.domain/policy/audit/audit_policy).

The client object space includes any KM Client names (e.g., kms://realm.domain/client/client_name), as well as KM Client meta data (e.g., home key directory, user policies, group memberships).

The group object space includes any collection of KM Client names (e.g., kms://realm.domain/group/group_name); KM Clients may belong to zero or more groups. KMS URI access control can be assigned to a group.

The pool object space includes any KMS key pool; a key may belong to zero or more key pools. A key pool allows for an arbitrary collection of keys. A key pool is also useful for organizing, managing, and searching for keys across key directories. Within the example URI kms://realm.domain/pool/pool_name, pool_name can be a multi-element path, so as to allow addition or removal of keys from a pool subject to access control. For example URI kms://realm.domain/pool/tape_backup/Europe_data_center, access to the pool is subject to the /tape_backup access control as well as the Europe_data_center access control.

The set object space includes any time-ordered list of keys wherein all the keys on a list are associated with the same data object; for example, data that needs to be re-keyed typically belongs to a key set, so as to facilitate restoration of older versions of the object. The set object space also includes key set metadata (e.g., oldest key, most recent key). A key may belong to zero or more key sets. Within the example URI kms://realm.domain/set/version_set_name, version_set_name can be a multi-element path, so as to allow addition or removal of keys from a list subject to access control.

The log object space includes any KM server log and also includes statistics about the log (note: some log URIs are write-only if written outside of KMS). A log object records KMS events and KM Client requested events. Within the example URI kms://realm.domain/log/log_name, log_name can be a multi-element path, so as to allow addition or reading of logs subject to access control.

The session object space includes any information related to an active session. For example, such information may include messages that the KM Client should retrieve; message URIs are of the form: kms://realm.domain/session/session_id/message/message_id. The session object space also holds statistical information about the session and KMS op IDs received but not replied to by the KM Server. The session_id shall be a nonce; an exemplary embodiment utilizes a session_id represented by a 512-bit value expressed in ASCII hexadecimal format. The session_id is typically an intractable value to predict; an exemplary embodiment would take a SHA-512 hash of at least 320 bits of entropy.

The domain object space is an object space reserved for the DNS domain; this allows for vendor and application extensions, which is useful for legacy key management systems, special vendor functionality, and special application spaces. Reserved object space begins with a “.” and reserved domains begin with a “..”.

### Key Management Architectures

As described elsewhere herein, components of a key management system typically include, but are not limited to, encryption devices, key generation capabilities, key archives, key backup systems, key retention policies, logging, events, and all of the appropriate operational procedures. Based on these components, the key management architecture must be chosen that best suits the organization needs and security requirements.

Typically, there are two types of key management architectures: centralized and distributed. Hybrid architectures are also possible.

A centralized key management system does not necessarily mean every function occurs in a single central location. Rather, it typically means that the administrator has centralized control over where each part of the key management process occurs and limits the points at which the keys and thus data can be accessed by users or devices that perform encryption.

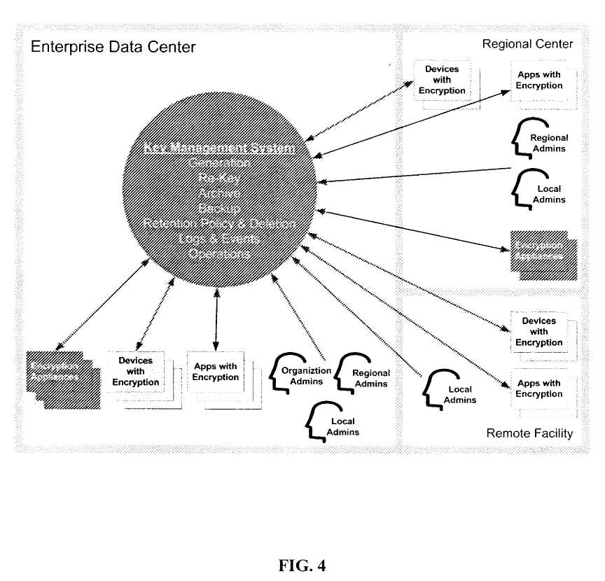

FIG. 4 illustrates the functionality of a centralized key management system. In this figure, each administrator uses the centralized system to perform any key operation that impacts either a portion of or the overall system.

A centralized key management system enables a larger number of processes to be automated more easily than in some distributed key management systems by ensuring that alerts and actions are propagated more efficiently. However, the key recovery process may be slower in a centralized system because more time is required to re-establish the keys at a remote site.

Distributed key management systems are designed to meet the needs of operations where communities of interest and trust exist. This means that users from other divisions within an organization do not need or have access to keys created and used by a specific division or group.

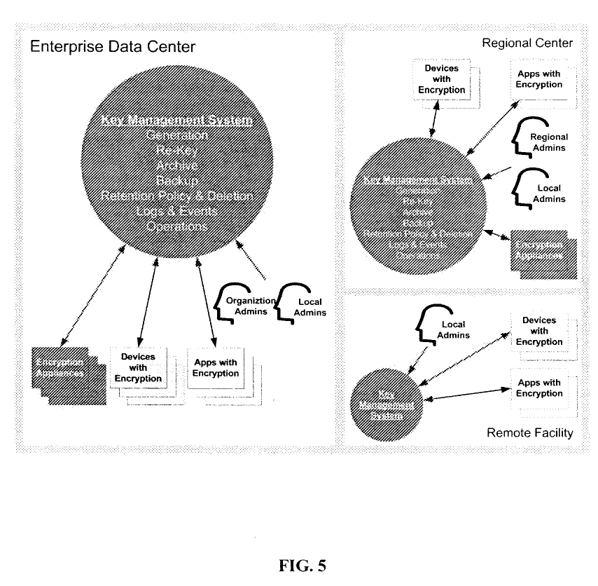

Users access each key management function—generation, distribution, use, archiving, and deletion—directly at a location or regional level, rather than through a centralized location. As shown in FIG. 5, keys exist in multiple locations.

This can make key recovery operationally easier than in a centralized system but often at the cost of a centralized audit trail. For example, if one site loses its keys, another site can be used to recover the keys without requiring the restoration of a backup from a central site where the persons may not be available to act immediately.

Distributed systems also provide better security mechanisms in place such that no one person or group of persons with specific interests can inadvertently or maliciously delete keys or logs that may be required for use at a remote location. A side benefit is that no one system can bring another down in the event of a failure or catastrophe.

However, placing one component of key management in one location and another in a separate location can make for a well-implemented key management system. For example, placing a key archive and a key backup in the same location is potentially disastrous to the key management system in the case of a site outage.

In many ways, distributed key management systems are easier to implement than centralized systems, but can be difficult to scale in large organizations due to the number of potential key management systems and the required persons to operate them.

With a distributed architecture, it is important that security is not sacrificed in the process. Access control should still be maintained and where possible from a centralized location.

If an encryption system contains internal key generation and archive, it should typically be able to backup keys in an automated fashion to a remote facility at a minimum. The more functions of the key lifecycle placed in an encryption device the more robust the distribution mechanism must be.

For companies that automate a large number of key management processes, distributed key management may not be a good alternative.

Hybrid key management systems take advantage of the best of both centralized and distributed systems, based on the organization's security and operational requirements.

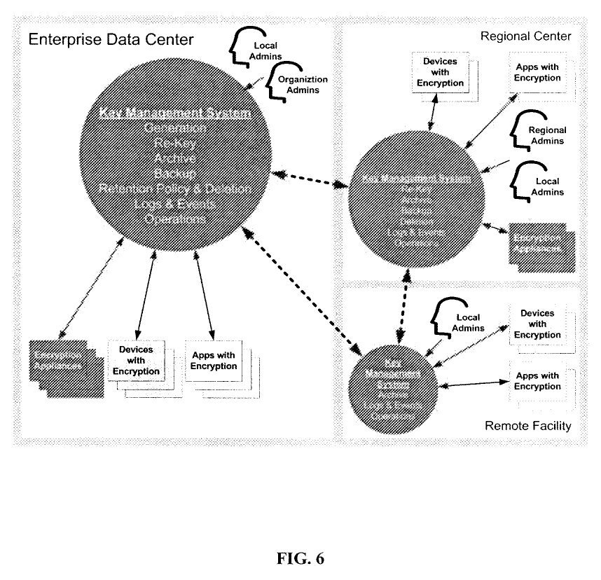

As shown in FIG. 6, key generation only occurs in a central location. However, logging and events are passed from various locations in the organization to provide both distributed and centralized logging facilities. The combination of local and centralized logging can also prevent missed log events using log comparison processes for audits or other forensic requirements.

Most key management systems on the market, while appearing to be centralized, have distributed functionality and should be architected as hybrids. One good example of this is a key management system that generates keys centrally, but implements key recovery mechanisms at the network edge.

Keys should be stored in one or more distributed archive, but control and logging are located centrally, while backups are done to remote facilities away from where they are used and archived.

Using the three architectures above, an organization needs to consider how best to implement the system based on single or multiple site configurations.

Different concerns exist when implementing key management at a single or multiple sites.

In a single-site implementation, particular attention must be paid to key backup and recovery. Re-keying and/or key deletion should occur any time there is a change in personnel that have access to any portion of the keying material. In addition, the organization should strongly consider placing key escrow at a third-party facility, but not before evaluating whether the escrow service can meet the organization's security and operational requirements for data recovery.

On the other hand, multiple-site implementations have the benefit of a remote site at which to replicate keys within the organization, as long as the appropriate security mechanisms are implemented. At a minimum, keys should be archived locally and regular backups should be conducted remotely to provide full recovery capabilities. Logging should also be replicated between at least two sites for local as well as centralized secure audit logging.

Depending on the number of sites in the implementation, it may be easier to begin with a distributed key management system, as long as it provides the ability to migrate to a centralized or hybrid key management system if the organization grows or the number of sites expands.

In a multi-site implementation, separation of duties such as administration versus security functions becomes more important, because information may be sensitive to the corporation or a specific department, so that not all sites in the organization should have or need access to the data. In this case, a centralized key management system is preferred due to the inherent access control.

While the key management system is part of an overall security strategy, security plays a very important part of key management itself, in the form of access control, authentication, and logging.

Access control within the key management system ensures who or what has access to which keys. The simplest mechanism is to allow all key administrators and all encryption devices access to all keys. The reality, however, is that not everyone or all devices needs access to the same keys. By limiting access to keys, the organization also limits its vulnerability to security risks.

Authentication of keys is always recommended if the keys are encrypted when stored. Authentication mechanisms themselves should be secure and authentications should only be performed on the encrypted data, ensuring that the clear text data is not leaked.

Lastly, the key management system should be configured to use a secure audit log server to log every event in the system. Administrators should have limited access to this server, and it should not allow deletion of a log without first archiving it using encryption, authentication, and a digital signature for the encrypted file. Access to the server for viewing the logs should be limited to audit users only.

### Exemplary Cryptographic Unit (CU)

This section will refer to all data at rest as objects unless differences should be taken into consideration for various media or data types, in which case it will be so noted.

Today, based on the point of encryption, there may be anywhere from a single key to millions of keys that will require management. As requirements evolve, this number could reach well over one trillion keys under management. For this reason a simple, easy to use key management service should be defined with the following considerations in mind.

There may also be cases where more than one point of encryption is used based on the type, sensitivity, and security requirements of the data in question.

Points of Encryption: Encryption can be performed at various locations in a system. A system includes applications, operating systems, file systems, hosts, network interfaces, networks, storage controllers, and storage devices. Each encryption point provides a different level of security, although exactly what is encrypted may be different.

Depending on the point of encryption, encryption may be performed in either hardware and/or software. For purposes of this paper, no differentiation is made between the two options and it is left to the end user to decide which the correct method is for their operations.

Based on current architectures, it is very likely that organizations will continue to use multiple points of encryption. They will base the type and location on the data requirements, corporate policies, and/or regulatory requirements to best meet the needs of their specific environment.

Points of encryption may also have their own key generation and/or storage capabilities but will still need to be integrated with a centralized key management service to provide ease of use when managing keying material.

With or without key management functions built into the CU's, centralized key management uses either a hierarchical, or a peer to peer based key management set of systems. The following are various aspects.

1. Application Encryption

Application encryption comes in many forms. Consider both an encrypted database application, and an encrypting backup. Database encryption provides encryption for data while stored in its own repository. Encrypting backup applications usually store data in removable media devices. Both applications have encryption functions, but each use encryption for entirely different purposes. Both provide various levels of encryption ranging from one key per database to potentially millions of keys, on a per record basis, active at one time.

While the keys will never be shared between dissimilar applications, it is still likely that keys may need to be accessed by multiple servers that run a high availability application such as email and database services.

2. Host Agent Encryption

Agents that provide encryption or links to off-system CUs may be used at the application level, OS level, or file system level depending on the use and function of the agent. The number of keys will be similar to those for each of the other points of encryption.

3. Host Hardware Encryption

Encryption engines are either built into the system hardware or implemented as pluggable modules that can be added to the system. These devices are sometimes referred to as hardware accelerators.

Hardware accelerators generally will require the use of software drivers to interface with applications, the OS, or other system components that require access to the CU.

4. Operating System Encryption

Operating Systems that provide encryption usually perform it at the file system level, or via API's that allow applications to use the encryption built into either the operating system software or the encryption hardware internal to the host system.

5. File System Encryption

Encryption performed at the file system level provides for encryption of directories, shares, or individual files based on rules that are set at disk, directory, or file system level. This method can require anywhere from a key per system to a key per file.

Special consideration should be given to how key per file may affect the KMS due to the sheer number of keys that would exist in larger organizations. The number of keys could potentially run to billions of keys that would be distributed over large geographical distances.

Cases like this will require that specific consideration be given to acceptable practices as they relate to where and how to place KM Servers throughout these environments, as well as how the response time for performing a key lookup is impacted.

6. NIC and HBA Encryption

Encryption at the host interface level requires an understanding of the data type that is being transmitted so that a decision can be made to base the encryption either on a specific target media (disk or tape), or to allow the application to call the driver to explicitly encrypt specific data types as they are stored.

7. Network and Fabric Encryption

Encryption performed in the network or fabric can be done in network devices such as switches or routers, or in appliances built for the task of encryption. Devices may support specific applications such as file encryption, tape encryption and/or disk block based encryption. The appliance approach may sit off to the side of a network as a proxy device or directly inline either as a proxy, or invisibly as a bump-in-the-wire.

8. Storage Controller Encryption

Storage controllers allow data to be managed on multiple storage devices. Storage controllers comprise array controllers, tape libraries, CD/DVD ROM jukebox controllers, or virtualization controllers that may also sit in the network between hosts and storage systems such as libraries or arrays. Encryption performed at the storage controller usually provides storage application specific encryption.

9. Storage Device Encryption

Storage devices are drives that have the ability to perform encryption as it is written to the media without requiring additional software or hardware. Cryptographic units include devices such as CD/DVD-ROM drives, disk drives, flash memory systems, and tape drives.

Storage devices will have the ability to perform encryption but may require external devices to provide key management functions. These external devices may be storage controllers, applications, or a dedicated key management interface that will provide connectivity to a standard KMS.

However, device encryption brings with it numerous considerations based on the media type. We will use tape and disk as examples: other media types may have additional considerations.

For tape media encryption, while the argument may currently exist that the media will never need more than one key, it is possible that future versions of drives may support more than one key for the media. This means that multiple keys may need to be kept at any time for a given piece of media. Currently, the only unique ID that is available is the media serial number. This would suggest that the media serial number should be used as the Key Set ID within a directory and each of the keys used for that media should be assigned a globally-unique identifier (GUID) within the Key Set. By doing this, the tape device can either retrieve the last key generated for that media from the Key Set, or the group (Set) of keys for that media that are still active.

Keys that are no longer in use may initially be disabled or destroyed. In this case, when a key is destroyed, its metadata should be maintained for audit purposes and only the keying material should be zeroed.

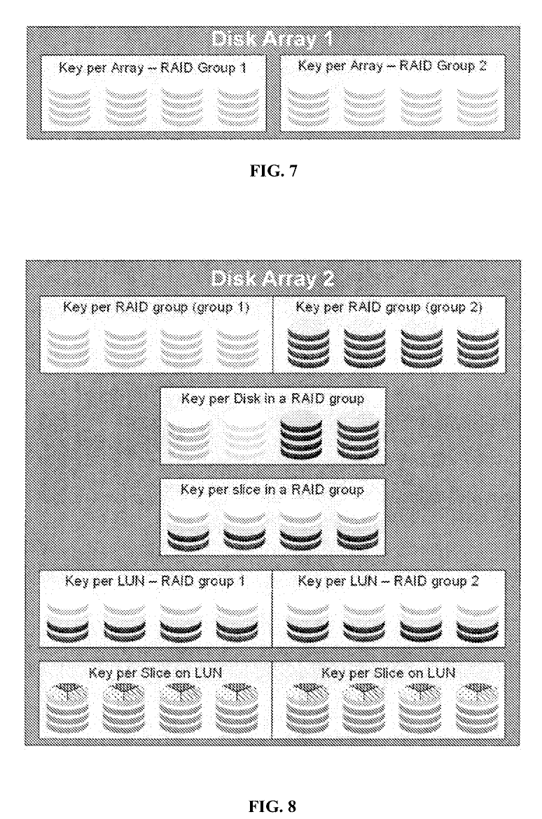

For disk environments, the number of keys is going to vary based on the level of encryption. As shown in FIG. 7 and FIG. 8, it is possible to have the one or more keys per disk array, per RAID group, per disk in a RAID group, per presented LUN, per slice in a RAID group, and per slice on a LUN; the technology is not limited to the configurations described herein.

Unlike other options, using one or more keys per disk array will only require a single or potentially two keys to encrypt the data. The second key in this case would be used as a key-encrypting key (KEK) to protect the first key if it is stored locally within the array.

Other cases of drive encryption (see FIG. 8) could be configured at the same time within the same array. In cases like this, the array may have tens to millions of keys depending on the array and capabilities. FIG. 8 shows the different kinds of disk encryption configurations that should be supported in order to provide the most flexibility and security for end users. The first configuration shows RAID groups using a common key; RAID group 1 uses a first key and RAID group 2 is encrypted using a second key. This allows RAID groups to be a single disk, or multiple disks used for similar data (same classification with the same owners).

The second option provides a key per disk. This has a benefit over Key per RAID by allowing for the removal of a single key in the event of a disk failure.

The third option allows different slices within a RAID group to use different keys and allows the user to allocate storage for different types of data within the same RAID group. This also works for Key per LUN shown in next option when a LUN does not traverse multiple RAID groups.

The fourth option brings the ability to use a key per presented LUN. This allows for control at a level that matches how most storage is managed. By providing Key per LUN support, disks can more readily be re-keyed, replicated, or destroyed as a single entity.

The last option has several benefits when LUN sizes become large, and the amount of data being written to the device would normally exceed the amount of data that could be safely encrypted using the same key without potentially exposing data or the key. The issue with a key per slice is that the encryption is performed on a block range or based on a partition table that is logically stored on the LUN by a host or hosts which may require additional overhead on the storage array or drives.

10. Encrypted Cache

While not generally used, it may be preferable in the future to also encrypt points where data has the potential to be temporarily stored. Caching of data can also occur at any point between the physical user of the data and its final storage point.

For that reason, caching may have a special set of requirements that may not be covered in this application. A cache should be considered to be any place that data is being stored even if only temporarily.

11. User End Point Encryption

The one point that does not fall into a normal storage network environment is the user end point such as desk top systems, mobile data devices such as a laptop, PDA or removable media (including flash memory storage devices) or externally attached stand alone drives.

Key management standards will have to take into account the requirements of systems that may not have connectivity to a network in order to access a KMS, and thus require local storage of keying material. This will also require thought on the security of those keys and how they should be maintained and controlled within the device.

Best practices here may require extensive use of PKI and certificates to keep data from being inadvertently copied to unauthorized destinations as plaintext instead of ciphertext. This last option does not provide the ability to deny malicious copying of data. Additional consideration should be given to object based encryption, and the associated key management that can be extended pervasively throughout an organization to protect the actual data no matter how it is used, copied or manipulated.

Key Management Operations: When describing client/server operations and interactions, the client can be a KM Client, a CU, or another key management system, while the server would be the key management system being queried or performing a key management action.

Additional mechanisms for import and export should be included in any system so that keys can be migrated from existing key management systems to newer or different systems where upgrade paths are not available.

Connectivity between a key repository and a CU should use encrypted communications so that keys may be transported securely. Connectivity should be established in a secure fashion as required. Further communications requirements are described elsewhere herein. The following are various aspects thereof.

1. Automated Versus User-Initiated

Key management services should take into account both automated and user-initiated functions and interventions when specific types of operations are performed, or events that require action occur. Either method for a specific action or reaction is up to the specific key management service being implemented by the key management operations.

2. Key Generation

For CUs that do not have the ability to generate their own keys, a request to an external key generation service should be made. Key generation requests should include the size of the key to be provided in bits.

Key generation is when a key is created either manually or by a RNG. Keys should be capable of being automatically generated, either by the encrypting device or by the key management service upon request from a CU.

If keys are manually created, then they should be entered at the KM Client or preferably the cryptographic unit for security purposes. Manual creation or entry of keys should not be allowed at KM server. Manually entered keys should only enter a KM server when stored by a KM Client, or retrieved by an authorized KM Client.

Terms that have been applied to random bit generators include DRBG, DRNG, NRBG, NRNG, PRNG, and TRNG. Each defines the type of generator being used. These terms are sometimes used interchangeably in the art.

3. Store Keys

Once a key is generated, it should be stored in a secure repository for retrieval when needed by authorized devices. Key stores should provide a mechanism for CUs to securely authenticate, connect, and store keys, without the potential to expose keys to networks or systems that may not be considered secure. This function is used in KMCS and KMSS communications.

Information and concepts as they relate to key management service and some of its underlying requirements may be found in NIST special publication SP800-57 parts 1 and 2.

4. Retrieve Keys

Similar to the function of storing a key, the need exists to be able to retrieve a key just as securely. This includes where the key was originally used to encrypt the data, and potentially, retrieval from other locations such as DR sites, remote facilities (branch offices) or partner sites that need to decrypt the media or object in question. This function is used in KMCS and KMSS communications.

5. Modify Keys

Several reasons exist for modifying keys. The initial reason is to modify the associated metadata such as changing an expiration date or some other component of the metadata associated with a given key. Modifying the key does not mean to disable or destroy the key. These functions fall under key removal. This function is used in KMCS and KMSS communications.

6. Key Search

Key search functions are required for key lookup when the media is read by a device that is not a part of the creating KM Realm but has rights to the keying material. Search will also be required for proof of audit when logging facilities are not or cannot be accepted as proof. This function is used in key lookup using KMSS.

7. Key Rights

Setting access rights to keys allows media to be mobile by allowing a key created in one key directory to be used in another if the directory structure is based on location versus logical devices. This allows for CUs to access media based on a set of policies that pre-determine access rights to keys. This query function is used for KMSS key exchange and lookup.

8. Key Tainting

The ability to taint a key should exist so that if a key is used on a system that does not meet a key's security profile then that key should be marked as tainted.

Once a key is tainted, it can still be used (or not used) based on policies put in place based on the key, key directory, or realm security profile.

Policy considerations for tainted keys are how a key can or cannot be used after it has been tainted, and should include disabling or destroying either automatically or manually.

9. Key Removal

Several functions that should be considered when deleting keys, include disabling, revoking, and destroying the keys. Each serves a specific function that is required when managing encryption keys.

Disabling a key applies to symmetric keys used to encrypt the data. The disable function keeps the key in the KMS. It also ensures the key will be removed from KM Client access. In an exemplary embodiment, in order to use a disabled key, a KM Client must be granted special access that requires permission from one or more authorized officers. A disabled key remains a disabled key for the life of the key until it is either restored or destroyed.

Disabling a key differs from revoking a key in that a revoked key may not be recovered for use again, while KM Clients within the KM Realm may later restore a disabled key for re-use. This function is used in KMCS and KMSS communications. In particular, disabled keys should be physically removed from any KM Client that has the ability to store keys.

In most cases, the Revoke Key function will only apply to PKI implementations that integrate with KMS systems. In these cases, the certificate revocation list (CRL) will track all keys that are revoked and it is the responsibility of a traditional CA to manage those lists.

There may be cases where PKI is not implemented but public/private key pairs are used for authentication and encryption of data at rest. In these instances, revocation applies to those key pairs that may be used to encrypt files or objects based on a single or small group of users. These keys may also be required for communications between services and CUs, so standard key revocation practices should be maintained. This function is used in KMCS and KMSS communications.

When a key has reached the end of usability based on lifecycle or exposure criteria, then the key itself should be destroyed by performing a zeroize function on the keying material which may include removal of the record after zeroize. It may be desirable for audit purposes to keep the associated metadata for some amount of time after destruction. This function is used in KMCS and KMSS communications.

10. Restore Key

Specifically applies to disabled keys when, for a known reason, the key is considered still safe to use on an ongoing basis without requiring additional authorization. This function is only needed if disabling of keys is allowed.

11. Replicate Key

This function is specifically used between KM servers to copy keys from the original server the key was stored in to additional servers. This function provides redundancy of key storage so that in the event of failure of a KM server, an authorized KM Client may still access the key. This function differs from Store key in that the receiving KM Server knows that it is not the originating repository of the key and therefore may not have rights to set policy for that key.

12. Import and Export Key

From time to time, a need may arise to import or export keys to the KMS when connectivity does not exist between two separate services. A common file/storage format and security mechanism should exist for keys that are exported to removable media including mobile devices such as laptops and PDA devices.

Another consideration is the policies used for import/export as far as what keys can be exported, who can export them, and who can import them at the far end. There should also be a way to translate a key from its current key wrapper so that existing keys are not exposed. For this reason the KMS should be limited to the number of wraps that are supported for keys. Different wraps can be added as technology changes as long as there is good key typing defined by the standard.

Exports should have the capability to require split knowledge, either for the security mechanism or for the file itself, even if a large number of keys are being exported.

### KMS Operations and Key States

The following subsections cover key states and basic key functions that are used in operating a key management service. The sections describe the requirements of each function performed between clients and service or between service and service.

In this section, service refers to a single KM Server or multiple KM Servers regardless of the KMS architecture.

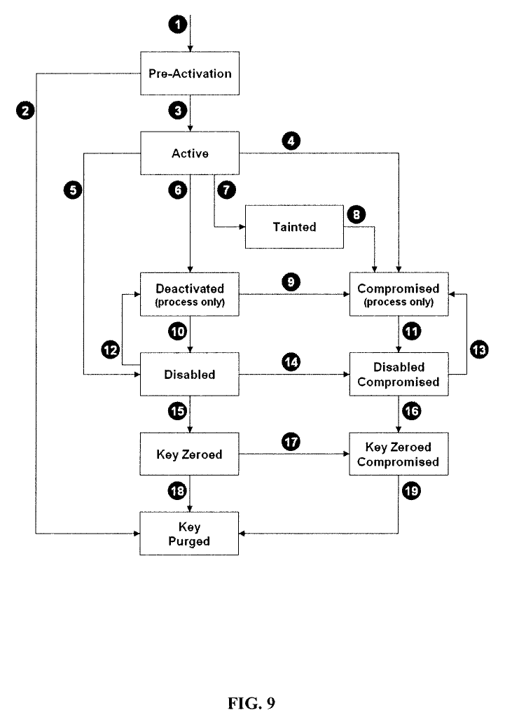

Key States: FIG. 9 illustrates a recommended model for key states (with recommended state values). A key operation sets the key to a particular state.

Pre-activation (state 0): Keys that are generated but not returned to a cryptographic unit are set to state pre-activation. Keys generated by cryptographic units are never considered in a pre-activation state.

Active (state 1): After KMS service generates or stores a key from a cryptographic unit, it is set to the Active state.

Tainted (state 2): A state specifying a key that has been requested and authorized for use by a cryptographic unit that did not meet the security requirements of the key. The key is still usable for both encrypt and decrypt processes.

Deactivated (state 3): A key that is used to decrypt only will be set to the deactivated state. In certain embodiments, this function must be configurable by a group manager via a user interface or time stamp.

Compromised (state 4): A key that has potentially been compromised but must be available for decryption by an authorized CU will be set to the compromised state. This state allows for a key to be used only to decrypt data. This state must be honored by cryptographic units in order to be enforced.

Disabled (state 5): This state applies specifically to data at rest. This state defines a key that has been destroyed on all cryptographic units and only exists in the KMS service but is not accessible by any KM Client. Keys can be transitioned directly from active to disallow use by cryptographic units in cases where the media has been lost or stolen. A KM Client can transition the key back to a deactivated state or the disabled compromised state depending on why the key was disabled in the first place.

Disabled Compromised (state 6): Keys that have been compromised at some point during their current lifecycle can be moved to this state either directly from compromised or from the disabled state. This includes discovery that they may have been compromised after they were disabled.

Key Zeroed (state 7): The Zeroed state denotes a key that is up for removal from the system. Keys that are zeroed still have all other metadata and time stamps left in place. This state keeps a key from being imported back into the system that may have been exported, backed up or stored elsewhere.

Key Zeroed Compromised (state 8): This state denotes keys that were compromised then destroyed or destroyed and then discovered to be compromised.

Key Purged (state 9): When the key record (metadata) is no longer required it may be purged by the system to release the SO_GUID and Record ID for reuse. Only the zeroed key and the associated metadata are deleted. All logged information about the key must still be maintained.

Key State Transitions: The model in FIG. 9 also illustrates key state transitions, exemplified as follows.

Transition 1: When a key is generated within a KMS system, but not returned to the cryptographic unit it is placed in the Pre-Activation state. Keys that are generated by cryptographic units stored in a KM Server are placed immediately in the Active state.

Transition 2: It must be possible for a key to be moved directly from Pre-Activation to Key Record Purged. If key has never been has never been active but is no longer required the entire record can be purged since there is no requirement for information pertaining to that key other than log information that it was created and purged.

Transition 3: When a Pre-Activated state key is requested by a KM Client it transitions to the Active state. If a key is exported singly, as part of a SO_Context or as part of a SO_Domain it must be transitioned to Active.

Transition 4: Active keys that have potentially been exposed or are considered compromised will transition to the Compromised state.

Transition 5: If a key is expired and no longer required for use it may be transitioned directly to Disabled state. This applies for symmetric keys that have an associated expiration.

Transition 6: Keys that are only to be used to decrypt information are transitioned to the Deactivated state. Devices that do not support decrypt only functions are not to have keys returned to them.

Transition 7: If a key has a minimum security level set and a device is allowed to request the key that does not meet that security level a key will be transitioned to Tainted.

Transition 8: Keys that are in a Tainted state and can still be used to decrypt only move to Compromised state. Tainted keys can only move to a Compromised state as the security level required for the key was not met at some point in its lifecycle.

Transition 9: Keys that have been deactivated for decryption only that are used by devices with lower security levels than required, potentially exposed or have been exposed but are still required for use are transitioned to the Compromised state.

Transition 10: Deactivated keys that are no longer required for any use are transited to the Disabled state.

Transition 11: If a key that has been compromised is no longer required it will be moved to the Disable Compromised State.

Transition 12: Keys that are required for use again may be restored for decrypt only purposes to the Deactivated state.

Transition 13: Keys that are in the Disabled Compromised state may be returned to use as Compromised for decryption only operations.

Transition 14: Keys that are disabled that have or may have been exposed during the accessible stages of their lifecycle or after they are disabled are transitioned to the Disabled Compromised state.

Transition 15: Once a key has been disabled and there is no requirement for it to exist anymore, the keying material may be zeroed while the rest of the key's metadata still exists. The key is transitioned to the Key Zeroed state.

Transition 16: Keys that are Disabled Compromised being zeroed are moved to the Key Zeroed Compromised state.

Transition 17: Keys that are found to have been exposed during their existence in a Key Zeroed state may be moved to Key Zeroed Compromised state.

Transition 18: When all information regarding a specific key is no longer required the metadata and zeroed key may be purged from the system completely. This may include ensuring that it will free the SO_GUID and the Record ID for use again. Logging information pertaining to the key must still be maintained even after deletion.

Transition 19: Key Zeroed Compromised keys that are no longer required can also be purged once the record is no longer required.

Before any key management services can be provided to a KM Client, a secure mechanism for moving keys should be established. Requirements for this mechanism should include: authentication, secure communications, and a common message format. By authenticating KM Clients with KM Servers, it ensures that the device (KM Client) is who it says it is and allows for access to only the keys that should be seen by that device.

Secure communications includes link encryption with negotiated keys and provides protection for keys that may be sent between a KM Client and a KM Server.

The common message format provides ease of programming for vendors to ensure interoperability with multiple key management systems as well as interchange of keys between like KM Clients.

Other functions that may be included as part of this mechanism are: negotiated security level of the KM Client based on standard definitions, secondary key management service location by name or address, key lifecycle policy definitions for KM Client, policy management system by name or address, audit facility location by name or address, and other security-related service locations by name or address.

Once service establishment is completed, other key management services can be made available to KM Clients.

KM Client to key management communications is based on the client/server model. In most cases, the KM Client (client) will initiate connections to the key manager (such as a KM Server), providing it with services. This application assumes that the communication is secure using link encryption or other acceptable methods.

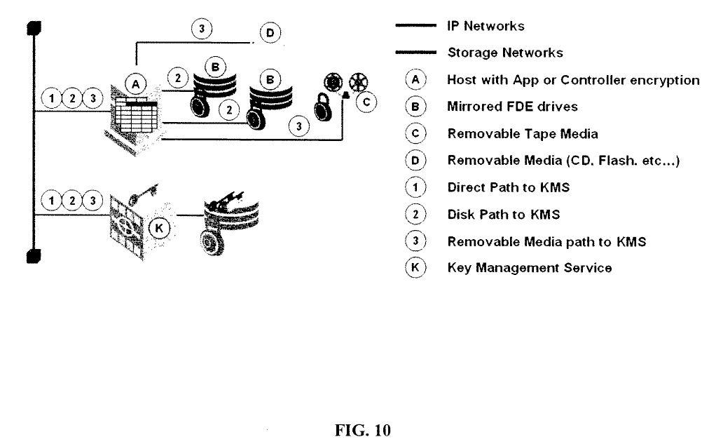

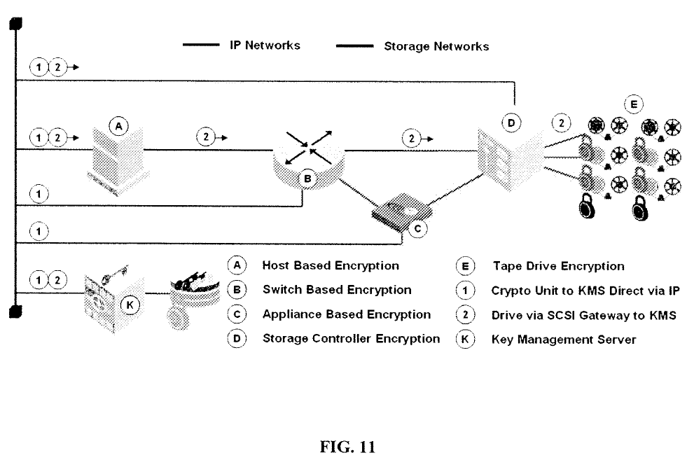

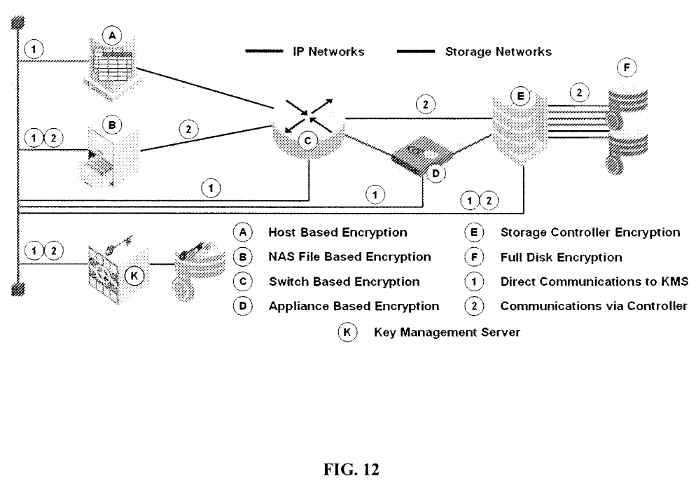

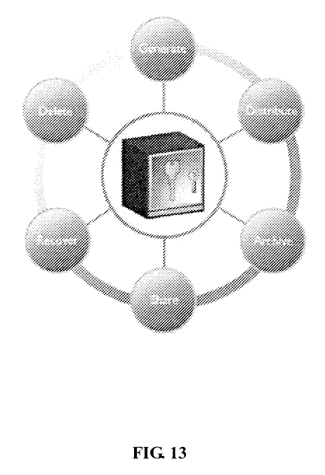

In FIG. 10, FIG. 11, and FIG. 12, the letters represent the various devices that can be used for encryption in one of three scenarios.

When multiple key managers are available, KM Clients will need to be able to select a primary and potentially a secondary KM Server that they can communicate with to perform normal key operations (get key, store key, etc. . . . ).

Depending on how the KM Client communicates with the KM Server the message may have to change protocol and format based on existing standards. An example of this can be seen in FIG. 10, FIG. 11, and FIG. 12 when the KM Client is the media drive performing the encryption function.

FIG. 10 represents internal or direct attached storage to a host where encryption can be performed either on the host as part of an application, a cryptographic agent, part of the OS, a hardware accelerator or media drive based encryption. When the media drives (B, C & D) contain a CU, the key should be sent by the KM Server to the host OS or application (A). The host then converts the key into a form that the media drive CU comprehends, usually through a driver.

For FIG. 11 and FIG. 12, where appliances are used as the KM Client, the appliances are shown inline, as this configuration can work as either a proxy or invisible device irrespective of the manufacturer.

FIG. 11 demonstrates how various KM Clients would get the media's associated key. Most KM Clients would communicate directly with the KMS using IP connectivity over a LAN, MAN, or WAN (1). Devices connected to storage networks using the SCSI protocol may require the use of T10 SSC3 signaling to get their keys (2).

In the case of SCSI communications, when the key cannot be passed directly to the CU, a translation function that resides in an associated application or intermediary device acting as the KM Client will interpret and translate the key messages between KMS server and CU.

It may be possible for appliances and network switches to serve as gateways for the keys, but this may also be impractical for reasons that need to be considered.

There still exists the requirement to pass the key to the KM Client using SCSI signaling over IP, SCSI or Fiber Channel depending on the drives own connectivity. The KMS may only have IP-based connectivity. Therefore, either all requests will need to be sent via a translation function found in the host (e.g. backup application) or a storage controller (acting as the KM Client) when using a disk array with FDE drives CU).

FIG. 12 shows primary storage using both SAN and NAS solutions for host to disk connectivity. Again, encryption can occur at any point in the connection between where the data is processed and where it is stored. Icon B represents a NAS gateway. The host shown in FIG. 10 could also be a NAS filer with direct attached storage such that encryption again can occur within the filer or on the drives themselves.

In all of the cases shown above, communications should be secure. Where possible, keep the number of options for protocols to a minimum.

A KM Client can issue a Key Generation Request to a KMS. As stated elsewhere herein, not all KM Clients will require external key generation. In cases where there is a need, or a stronger RNG source is available externally, then a request should occur from the KM Client unit to the KM Server.

Request messages from KM Clients for keys are sent to the KM Server or servers that are responsible for that KM Client. If the device is only connected via SCSI signaling via IP, SCSI or Fiber Channel, then the above mentioned gateway function might be required.

In addition, if the KM Server in question does not have its own RNG function that meets the requirements, then it may have to forward a request to an external RNG device. For this reason special consideration needs to be given to time outs for requests before either a failure or some pre-assigned action takes place.

Keys that are generated should not be stored until used. Just because a device requests a key does not mean that the device will immediately use the key. Devices that have limited capabilities when communicating with a KM Server should be able to request a key, and then store it as a separate transaction once the key is to be used or is in use.

A KM Client can issue a Key Store Request to a KMS. Storing keys should only require a single session from a KM Client to the KM Realm although some vendors may prefer to have the KM Client talk to two KM Servers within the KM Realm there should be a mechanism in place to avoid storing the same key using two different identifiers.

To help avoid this issue, a GUID should be assigned by a KM Server that is based on a unique ID within a given realm/directory/set of keys/key id. The KM Client (CU) associates a Key ID with the media. The CU may use a media serial number or it may use a randomly generated value not previously used as a Key ID. When the key is stored, the KMS will convert the Key ID into a GUID and return that GUID back to the CU. This is done so that the CU may receive the key from a different KM Server by means of the GUID.

This would also allow the storage of the key on a second KM Server that may not be a member of the KM Realm as may be the case when escrowing keys.

Once a key is stored in the KMS, the key should be accessible anywhere as long as all of the appropriate credentials and privileges exist to access that key by the requesting KM Client.

A KM Client can issue a Get Key Request to a KMS. Getting a key from the KM Server is also a single step process of requesting the key from the primary KM Server for that KM Client. In the event that the key does not exist on the KM Server, a lookup will be performed in the KMS using the GUID of the key or other searchable metadata that can help identify and locate a given key.

When a KM Client is requesting a key from the Key Directory in which it was created, all that is required to get the key is the key ID. In the case of tape media, this could be the media serial number.

The media ID may be used as a Key ID if it is a globally unique value. Because volume serial numbers and external media barcodes may not be unique values, they are best used as key names. A media's key may be retrieved by name by means of a “Find Key” operation.

The more information a KM Client can provide (if it does not have the full GUID) allows a KMS to make sure that the appropriate key is returned to the KM Client. Moreover, the KM Client and media should ensure that the key can be identified properly using either cryptographic authentication, or by using a digital signature of the key. This will help prevent decryption with the wrong key. Standards such as P1619 are ensuring this is the case for both disk and tape based storage. The same should be true for any storage medium that uses encryption no matter where the KM Client is placed.

A KM Client can issue a Find Key Request to a KMS. When a KM Client needs to obtain a key by the non-unique key name, or by some other non-unique criteria such as a creation date, it issues a find key operation to the KMS. Find key may return zero or more keys. The KM Client selects a key from among the keys returned. The KM Client may have to request an application to select from the multiple keys.

Finding a key may be limited to a KMS search of keys that are directly under a given Key Directory. It may also recursively search for keys in a directory tree starting at some given Key Directory.

A KM Client can issue a Remove Key Request to a KMS. Key removal, as mentioned previously, is really one of several functions.

In most cases, a KM Client will not be allowed to destroy keys. It will only have the ability to disable keys within the KM Realm. This limits access to keys that, while destroyed at the client side, may only be disabled in the KM Realm. It may also be desirable to not allow the destroy key function to be passed to other clients until one or more KMS key administrators decides on what action to take with the key. One recommendation is to disable the key in the KM Realm, destroy it on all client CUs, and generate an alert or event that lets the KMS key administrators decide if the key should be disabled, revoked, or destroyed based on the key type within the rest of the KM Realm.

A KM Client can issue a Revoke Key Request to a KMS. When a standard PKI system is not available and there is use of public keying, it should be possible for a KMS key administrator to revoke a signed public/private key pair that is being used to encrypt a data object, encrypt another key, or for secure authentication.

This will be most prevalent in the case of authentication and, while a KMS or client may request a revocation of a key, it should only be possible to do so if it is the signing authority for that key. In most cases, where it is similar to a KM Client to service delete key function, it should be left up to the appropriate signing authority administrators or a certificate authority to determine if a public/private key pair should be revoked using existing standards for revocation of keys.

There should be a mechanism for a revocation request to come from a KM Client to KM Server to a PKI system.

A KM Client can issue a Destroy Key Request to a KMS. No matter what function is performed, KM Clients and CUs should zeroize all copies of keys being destroyed. This means that keys that are disabled, revoked, or destroyed in the KM Realm should first be removed from KM Clients using standard messaging and acknowledged.

Unlike other communications requirements, this might be a case where the service initiates communications to the KM Client. However, serious thought should be given to not allowing KM Servers to initiate communications except with one another.

In cases where multiple users are required to destroy a key within the KM Realm, it should be the same policy for edge devices unless a key can be disabled within the KMS and destroyed at the CU where it may be cached or stored.

A KM Server can issue a Replicate Key Request to a KM Server. An typical feature of any KMS is the ability to provide redundancy and high availability especially for encrypted data at rest.

Keys can be placed in two or more different KM Servers either by the KM Client or by the KM Server where the key is originally stored. These options can be synchronous or asynchronous in nature as long as it meets the specific requirements of an organization using key management services.

To offload processing from KM Clients and to allow them to focus on their primary function, the KM Server that received the key will be responsible for replicating the key. This will also help to avoid having the same key with different GUIDs in two KM Servers.

A KM Server can issue a Lookup Key Request to a KM Server. The Lookup Key operation is used where media is removable and needs to be accessed at a location that does not have access to the KM Servers where the data encryption key is stored. The potential for this happening is significantly increased with media such as tape or other removable media.

When this case occurs, a KMS server-to-server lookup is used to find the appropriate key. An exemplary embodiment has globally unique identifiers for each KM Server so that when a hierarchy of servers, key directories, and keys exists, there is a way to create a guaranteed unique ID.

A GUID, in identifying where the key was created, should not do so using a physical address because KM Servers and KM Clients may be retired over time. Specifically, there needs to be protocol that can be used to do a key lookup quickly and without requiring any foreknowledge of where that key might be physically located.

Lastly, for lookups, it should be the responsibility of both the requesting KMS and any responding KMS to ensure that the KM Client is authorized to use a requested key. For this reason, policies for accessing keys need to be replicated globally between all KM Servers in the KM Realm. Alternatively, a centralized key policy server that keeps track of all policies in the KM Realm explicitly designates one or more central locations where policy information is maintained.

A KM Server can issue a Disable Key Request to a KM Server. The disable key function is one that should be reserved for KM Servers to use between each other. Any time a key is to be disabled, it should be destroyed in any KM Client or CU that stored, cached, or was actively using the key in question. The key should then be disabled in all the KM Servers to where it was replicated.

When a destroy command is issued by a KM Client it should be optional to only disable it within the KM Realm.

There may be specific reasons to temporarily allow access to a disabled key and this should only be done if the appropriate authority or authorities allow it on a use-by-use basis until the key is either restored or destroyed. Specific controls on restoring a key should be considered for disabled keys as well.

A KM Server can issue a Revoke Key Request to a KM Server. Key revocation lists are usually controlled by Certificate Authorities, however in the case where a CA does not exist and KM Servers are acting as their own signing authority, there should be a mechanism to revoke certificates and public/private key pairs from a KM Client.

If the KM Client has more than one certificate, the KMS should optionally allow for a single revoke to revoke all certificates in the KM Realm.

A KM Server can issue a Destroy Key Request to a KM Server. Destroying a key in the KM Realm should be capable of propagating to all KM Servers that may have stored or accessed a key to ensure that the key is truly destroyed. KM Servers should also keep track of any exports that were performed on a key so that they may be tracked if necessary to prevent the potential exposure of stored data.

This is especially critical in the event that media is lost or stolen and an audit of the key destruction is required. For this reason it may be desirable to not destroy the entire record but instead only zero the key so that the record itself is still accessible for reporting purposes but not for decrypting data.

Even though a key that has a zero value is normally valid, it is very rarely accepted. For this reason, there should be mechanisms for testing a key before use by using cryptographic authentication such as HMAC or some other secure hash function.

A KM Server can issue a Restore Key Request to a KM Server. Restoring keys that have been disabled should only occur in the KM Realm. Since a restored key should previously have been destroyed at the edge, if the media is inserted, the key that was restored is immediately available for use by an authorized KM Client without any special permission required to access it.

It is also possible to configure a KMS to communicate with a mobile device. The one case where it may be best to use Public/Private keying versus strictly symmetric keys for encrypting data is on mobile media. For example, one may store private key data on a single system.

Additional thought needs to be given to just how and what is to be encrypted on a mobile device since control and connectivity will, from time to time, be unavailable other than locally.

### Key Management Services

The actual services being provided by the KM Realm will include a number of services that are directly related to the management of keys. These are the basic services needed to run a key management operation. Functions typically include (and are not limited to) actual key management, client interaction, and service-to-service interaction.

Management of keys consists of the functions described elsewhere herein that, when used together, form a system of control that allows security personnel to ensure that data is protected throughout its lifecycle when stored. The basics of key management include key management operations listed above that are either automatic or manual in process, as well as including lifecycle management functions that allow a key to be followed throughout its useful life and beyond as required.

KMS functions: As previously described, there are a number of KMS functions, however the present technology is not limited to the functions described herein. Other functions could provide more management functionality, including, for example reporting and access control. More advanced functions include lifecycle management that allows for controlling a key from creation to removal, and setting basic retention policies that allow for keys to automatically be re-keyed, disabled, revoked or destroyed.

Lifecycle Management: Lifecycle management encompasses all phases of a key's life that includes creation, distribution, storing, sharing, recovering, and removal. Each of these phases has specific actions that are associated with them that may or may not be automated by the KMS. Others may require alert and event mechanisms in order to generate a manual or scripted set of actions.

The diagram in FIG. 13 illustrates a six-phase lifecycle of an encryption key. Various key management schemes may include more, but most of those will usually fall under one of the six phases. The Generate phase occurs when a key is manually or automatically created for use by a KM Client. The Distribute phase comprises providing the key in a secure fashion to the appropriate and authorized KM Clients or KM Servers that need the key to decrypt stored data. The Archive phase comprises storage of keys in a KM Server that allows for retrieval on an as-needed basis. The Share phase is when a key is allowed to be shared with entities other than a normal KM Realm where the key was created. The Recover phase occurs in the case of severe disasters or malicious actions on the part of one or more KMS managers; recovery of keys typically uses a secure mechanism for backup outside of the KM Realm. The Remove phase, as previously described, consists of multiple types of key removal which include disabling, revocation and destruction.

Another, more detailed, model for key management lifecycle can be found in NIST SP800-57 March 2007 Recommendation for Key Management—Part 1: General (Revised) Sections 7 and 8, incorporated herein by reference in its entirety. Models other than those described herein do exist and can be considered for building a full model that applies specifically to data at rest key management. The technology is not limited to the embodiment of a key management lifecycle described herein.

Retention Policies: Key retention policies are another basic set of policies that are an important element of KMS services. Retention is the amount of time a key can be used before it has to be either be re-keyed or removed. This function, at a minimum, should work at a KM Realm level so that a policy can be applied a key wherever it is stored within the Realm.

If retention can be set on individual keys, a KMS should provide for mechanisms to report exceptions. E.g., when there is a policy controls a key's removal time, and the key's retention time is modified beyond the removal time, then an exception should be raised.

Consider the case of an object under the control of a one-year re-key policy as well as a key retention policy. If a KM Admin extends the retention policy beyond the re-key policy time, then the KMS should log a policy exception event. The KM Admin, when notified, will need to resolve the policy conflict.

Special consideration needs to be given to keys that are used to protect data that is stored on write many/read many media such as disk since there is a potential to overrun the birthday bounds of an encryption algorithm (varies based on mode used).

Key Sharing: While sharing of keys is not a new concept, in order to build a model that works not only between various departments within an organization, but also with partners that require access to sensitive information, the model should use common formats, policies and communications mechanisms to access keys. These methods should include secure ways to share keys over networks, via email, via smartcard or other such mechanisms.

Keys that are shared should be wrapped in a common format for a specific application and the KMS should have the ability to unwrap and rewrap. This could be potentially done using a public key from the partner for encrypting the data encryption key.

KM Client Interaction: KM Client to KM Server interaction is based on actions required for the KM Client to perform its function without being impacted by the KMS. To this end, special thought should be given to limiting the amount of overhead a KM Client should deal with when establishing and maintaining communications with a KM Server.

KM Server Discovery by KM Clients: Discovery of a KM Server by a KM Client should support manual input of the KMS IP address at a minimum. Thought should be given to defining a protocol that will allow for the KMS to automatically be discovered so that if a KM Server that is being used by a KM Client fails, the KM Client can lookup and discover another KMS that it is allowed to use such as a specific failover system or a remote KM Server.

When a KM Server is used as a failover or remote KM Server, then the KM Client should replicate keys to it. Thus, when a KM Client request for a key is received, the failover or remote KM Server can respond to the request directly. As a worst case, the KMS should have a way to find the appropriate KMS if it cannot be automatically discovered.

Levels of Interaction and Security: Levels of interaction between a KM Client and KM Server should be defined so that basic cryptographic devices can be interoperable with a minimum amount of effort. This includes communication protocols, message formats, and key information.

KMS: Server to Server interaction: KM Server to KM Server interaction (KMSS) utilizes additional signaling. KMSS exchanges more information within the KM Realm. This information can include key replication, policy replication, and existing KMS hierarchy or peer communication establishment.

This information should also include the level of functionality provided by each of the KM Servers in terms of whether it is defined as a FIPS 140-2 cryptographic boundary, Common Criteria earned assurance level, or some other industry standard of security.

This will help control keys so that keying material is not potentially exposed by a system that did not meet the security requirements in order to access a key. This might result in a tainted key.

Key and Policy Replication: Key replication is of critical importance when configuring multiple KM Servers. The replication policy includes the identification of potential replicating KM Servers, including the minimum number of KM Servers a key should be stored on. The policy should also define which servers do the replication. E.g., only the KM Server where the key was originally stored, or each KM Server where a key lands.

Policies for keys also need to be replicated specifically as they relate to directories or sub-directories of keys where specific retention rules exist. E.g., what functions can be performed on a key, what a key directory's security requirements are for storage, or other such policies.

This protocol should be specific in definition and, if possible, use a limited number of existing standards to alleviate the need for development of a new protocol or message format if they are defined elsewhere.

KMS Hierarchy or Peer Discovery: Lastly, it may be in the end user's interest to use a peer based KMS or a hierarchical based KMS depending on the environment and how it best meets the needs of the organization.

Peer based systems make each KM Server responsible for key distribution and policy enforcement.

A hierarchical KMS will usually have a central console with edge KM Servers that report up to, as well as take policy and other key management requirements from, the centralized KMS authority.

When developing a communications mechanism, both topologies should be taken into account with a preference towards peer based, since it is easier to convert to a hierarchical system.

### Other Requirements for Key Management Services

Other requirements for KMS include, but are not limited to, additional services that are important in most operations but do not have direct impact on day-to-day key management operations other than monitoring, alerting, and auditing.

Policy Management Services: Policy management goes beyond just setting retention policies for keys. True policy management takes into account key lifecycle requirements, key retention, key security requirements, data classification, and other security-based parameters, so that when data is first stored, it is secured properly with the correct type of encryption and other security metrics.

Policy management is generally understood by those skilled in the art, and is described elsewhere, but the following lists some of the considerations when designing a KMS.

1. Access Control by KM Clients

Policy configuration should include the ability to limit a KM Client's access to specific KM Servers, as well as limiting its ability to access specific keys for retrieval. Access controls should be configurable with global defaults at the KM Realm, KM Server, and key directory level, and potentially down to individual key level.

Individual key support may be required if keys are to be shared by KM Clients that store their keys in a specific key directory, and the required keys are from a different key directory.

2. Security Requirements of Data at Rest

Based on specific requirements of the data being stored, it may be necessary to provide different types and strengths of keys to the same KM Client if data being stored has different requirements from object to object.

Some of the parameters that may need to be taken into consideration when setting security-based policies include: data classification, the storage devices in use, user access to data, mobility of data, and replication requirements. In an exemplary embodiment (a well-configured storage environment), data classification takes into consideration the other parameters in the list.

3. Key Management User Rights

Based on a user ID or user class, security rights can be configured to the point that each function that can be performed could be assigned to individual KM Clients. However to ensure that some level of interoperability can exist, a common set of functions and user classes should be defined, such as those previously described.

Rights to keys should be defined based on a directory structure such that specific users can be given access to only specific keys in a directory tree. The granularity of control of those keys may be as fine as a singular key, but again for interoperability purposes, thought should be given to defining to at least the directory level just below the root directory.

In this model, a root directory would consist of multiple key directories that would be classified based on a CU or CUs in one or more locations. These CUs would share a common set of keys and allow keys to be shared between those CUs without the requirement of having additional policies in place for sharing of the keys. This does not remove the ability to limit access to a key within a directory by setting a KMP on an individual key or pool of keys.

Key management users should be extended to a KM Server when a directory they have responsibility for is replicated to another KM Server. In the case where a common authentication mechanism is used this may be a non-issue.

4. Key Sharing Mechanisms

Key sharing becomes important when data is to be shared across multiple departments or potentially with partners that need access to specific data. For example, if an encrypted file or encrypted media (e.g., encrypted tape) must be sent outside the KM Realm, then the key may need to be shared. That is, the key is given to the external entity that needs to read the encrypted file or media.

The other department or partner would need access to that specific key to access the data in the file or on the tape. Since the other group does not need access to all keys within a directory structure, a policy mechanism should exist to allow the key to be shared individually without requiring a lot of manual operations or intervention.

Key Wrapping: Considerations for common key wrapping mechanisms also need to be put in place such that if a key is used to encrypt a specific type of tape media that is shared with a business partner, the device at the partner site can understand the wrapping mechanism being used, as well as authenticate the key before its use.

One note on key wrapping is to ensure that like applications or media use a common set of key wrapping techniques, or that a KMS server can understand and translate the key between two disparate systems that require access to the same data and thus the same key.

The standard that defines encryption practices and uses for specific types of data and/or media should recommend wrapping methods for their keys, or specific wrapping mechanisms should be defined as part of an overall KMS system specification.

Key Sharing Policies: Once a key is shared, consideration needs to be given to the period of the allowed share, the number of times a key may be used, or who may access it if it is exported to an encrypted file.

For this reason, policies that relate to individual keys should be able to be transported as part of the encrypted key file that is exported.

Key Exporting: When a key file is opened, the policy should be enforced to the point that a notification mechanism exists via email, remote system log, or other notification mechanism, that can be sent back to the originator for auditing purposes.

Additional considerations will need to be given to what level of controls can be put in place for keys that are transferred manually via token or other removable media, and that may be used in devices that are not network connected.

5. Re-Keying Data

From time to time it will be necessary to re-key encrypted data. Options for automating this function should be considered. One option is to pre-define policies or automatic functions based on data chum (amount of data written within an amount of time using the same key). In most cases, this will be for media that can exceed the birthday bounds of a cryptographic algorithm and mode of operation.

A standard should make allowances for enforced re-keying based on key utilization or based on time. Key utilization should be measured over time to make appropriate recommendations for re-keying based on the algorithm in use.

While this may not be a concern for most types of media, larger LUNs used in disk applications may require forethought. An example is the use of AES256. AES256 can write just under 264 bytes (18,446,744,073,709,551,616 bytes) before the birthday bounds would be exceeded (depending on the mode used with the AES algorithm). While most LUNs will not come near to this size, the amount of data being written may potentially exceed this in as little as two years on high utilization disks.

Whenever re-keying data at rest, consideration should be given to using a key set for tracking versions. This will alleviate any potential issues if data is replicated while encrypted and the end that was replicated is not re-keyed in real time.

Another reason to re-key regardless of the media type is if a person who had access to keying material leaves the organization. The level of keys the person had direct access to determine what should be re-keyed.

By automating or planning for manual re-keying of encrypted data, it should be possible to alleviate most of the operational burden that is normally associated with re-key operations.

6. Key Replication Policies

Policies for replicating keys between multiple KM Servers should be included in any standard so that the appropriate authorized persons can control distribution of keys.

When a key is replicated, it should be replicated to a common directory structure that may exist on multiple KM Servers. The directory structure should include the originating KM Server in the path so that duplicates of local machines do not exist based on common names.

This would also potentially allow the users that have rights over a directory that is replicated to multiple KM Servers to be consolidated and shared as well. This is, of course, as long as a common authentication mechanism can be used to ensure the users are who they claim to be.

Monitoring Services: Monitoring functions will serve the purpose of ensuring that the KM Realm is operating normally. Various functions will need to be monitored by traditional operations outside of security related operations, since the KMS has the ability to impact data at rest within a given organization.

Functions that should be considered are basic operations-related functions and security-related functions.

1. Basic Operations-Related Monitoring Functions

Basic monitoring functions include system status, uptime, environmental and other operating conditions that may degrade performance or disable a KM Server altogether. For this reason, functions should be included that allow for traditional management tools such as SNMP management tools, SMI-S/ILM tools, system logging and other event correlation system to have basic access to the KM Realm.

2. Basic Security-Related Monitoring Functions

Security related monitoring needs are easily defined as anything related to communications between two end points in the KM Realm that include servers, KM Clients, and the networks that the communicate over.

This means that all key storage, key requests, key use, key export/import operations, key replication, key removal and other actions that impact the KM Server should be monitored, logged and where applicable alerted.

New standards are currently in development for secure logging functions that should be included in any considerations for secure monitoring functions.

Reporting Services: Reporting services are services that pro-actively, in near-real time, allow for notification of potential or new problems. There may be a need for certain events to repeat at regular intervals depending on the severity of the condition.

When defining a base level of KMS alerts, severities should be taken into consideration and based on existing severity levels established by monitoring and reporting standards. The following are factors for reporting services.

1. Standard Alerting Mechanisms

Current standards for event and alert notification include SNMP traps, active system log parsing, email event notification and console alerts. KM Servers should provide at least one mechanism for actively alerting end users that a problem exists.

Other mechanisms may exist that should be included with these to provide the end user organizations of KM Servers the ability to integrate into existing operations. This should also allow them to set up appropriate responses based on a set of conditions such that automated functions can be enabled using event and correlation management tools.

2. Event Management and Correlation

A very useful tool for providing automation and alert functions, are event driven correlation engines used for security, network, and systems management. These tools make it easier to spot problems or potential security threats before or as they occur.

Based on the final key management specification, real consideration should be given to ensure that appropriate interface mechanisms are given to these tools to enable organizations to easily adopt KMS services without adding a lot of operational overhead.

Secure Audit Services: Audit logs should include, in a sequential order, every event for actions taken on a key. To avoid the potential problem of differences in times and actions for an event, all alerts, events and security related logging should have a numbering mechanism that is used globally for all KMS services so that events can be sequentially reported without the differences in time as well as to prevent the potential of time modifications.

Since keys for encryption literally are becoming the keys to the kingdom in today's organizations, every effort should be taken in developing the KMS standard to include minimum requirements for auditing functions. This is due to potential and real liabilities associated with non-compliance of regulations and loss of personally identifiable information (PII data).

The idea behind providing secure audit logs is that if an organization can show where and when a key for specific data has been used, accessed and finally destroyed, that liabilities related to protecting data that was lost while encrypted can be controlled.

Another consideration for the use of a secure audit log is that when keys are shared, it allows the exporter to require a log event be sent and acknowledged when a key is imported and prior to the use of the key. This may not be possible due to security constraints of end user systems, but should be given thought to on how it might be accomplished. This would assist in the limitation of liability associated with data being shared between different organizations.

The following are desirable attributes of a Secure Audit Log:

Secure audit log entries refer to all actions and events related to a key. They should contain as much information as is available. Information should include at a minimum: (1) the type of entity that performed the action (e.g., KM Client, KM Server), (2) the reason the action is to be taken (e.g., potential for KM Client input or messages such as encrypted tape loaded for read/write operations, file replicated to remote system), (3) where the action was taken from (e.g., IP address of KM Client at time of action, CU identifier, KM Client, KM Server), (4) when the action was performed (e.g., secure time stamp, event number).

Secure audit log events should be managed such that removal or export for external uses is controlled based on a metric that allows for multiple person control and that specific alerts should be generated.

Any entry into a secure audit log should be cryptographically authenticated across the entire record. When records are exported they should be encrypted and signed using a public/private key pair of the person or persons that are to receive the file and once again cryptographically authenticated individually as well as for the entire exported list.

Backup and archive of secure audit logs should typically be implemented before removal of any active log entries. Consideration should be given to requiring two or more archives in different locations if entries are to be cleared for performance or storage purposes.

### Additional Key Management Services Considerations

The last set of considerations for KMS standards may or may not be required to define a standard. These are just some of the additional assumptions made for the use cases above that should be considered to ensure they fit with any extensions to the standard or other standards that are developed later for KMS.

Key Attributes: The list of key attributes, found in the table below, include attributes that may be unknown to a KM Client. Some of the attributes are specifically included to allow for management functions such as audits, key lifecycle management, and other functions that do not require the values to be seen outside of the KM Realm.

TABLE
Key Attribute List

| Attribute | Description |
|---|---|
| Creator name | Key generator device name or ID |
| Creator metadata | Information provided by key generator |
| Creation time stamp | Time a key was generated or entered into the system |
| Key access rights | Level of rights required to access a key |
| Key destruction time stamp | Time when a key was actively erased |
| Key Directory | Key directory which stores a common set of keys and |
| | parent keys that generally share key type, policies, and |
| | common access control |
| Key disable/revoke time stamp | Time when access is no longer allowed to a key |
| Key Encoding Format | Method by which value of key is presented (i.e. Base 16 |
| | ASCII, B64, etc. . . .) |
| Key GUID | Globally Unique Identifier for a single key |
| Key ID | An identifier of a key that is unique within a key |
| | directory |
| Key Name | A non-unique identifier of a key (often a human |
| | readable key name such as a tape barcode label or file |
| | name) |
| Key Pool | A collection of keys. A key may belong to zero or |
| | more key pools |
| Key Security Profile | Security requirements for access to, and use of, a key |
| Key Set | An ordered list of keys associated with a common data |
| | object (e.g., multiple versions of a key) |
| Key Set GUID | Globally Unique ID for a Key Set |
| Key Set ID | Identifier for a Key Set (e.g., multiple versions of a |
| | key) |
| Key Use | Description of how a key's use is limited to a particular |
| | type of data (i.e. Tape, File, Disk, etc. . . .) |
| Key Value | Encryption Key |
| Key Wrap Format | Description of how key value is bound (i.e. AES Key |
| | Wrap) to other information (i.e. Key Value, MAC Key, |
| | Parent Key, Name, etc. . . .) |
| Modification time stamp | Last time a key or key metadata was modified |
| Parent Key GUID | Globally Unique ID for a Key encryption key (KEK) |
| | used in a hierarchy for protecting media keys |
| Policy name | Policy applied to a key, key directory, key set or key |
| | pool |
| Tainted Key | Key that has been used in violation of its security |
| | profile |
| Vendor metadata | Vendor specific data that relates to a key or key set |
| Version of the Key Set | Version of the most recently added non-disabled key in |
| | a Key Set |

Each device should support a minimum number of attributes, and those attributes should be determined both for interoperability, and as a minimum set of requirements to work with any standard KMS. As a minimum, the following attributes should be considered: Key Name for human readability, key ID that can be a unique identifier within a directory of keys

Based on a global architecture, each key will have both a key ID assigned by the KM Client, as well as a guaranteed, globally unique identifier assigned by the KM Server. The GUID should consist of KM Server information as well as the key ID. Using the two together allows for uniqueness of a given key as long as every KMS can be uniquely identified to begin with (such as with an Ethernet MAC address, serial number or other globally unique identifier). However, a GUID should not be confused with a specific address, as keys may need to move from location to location while the media they are used to encrypt will only have an original identifier with which to find them. Based on this, a GUID will be critical in finding keys when global distances and replication are involved.

Secure Communications Considerations: When KM Clients want to communicate with a KM Server, a secure mechanism for establishing, using, and maintaining communications should exist. It should not matter what transport mechanism is used. Whether it is an IP network or SCSI transport, all transactions that include keys should be secured. The following are aspects of communications with a KM Server.

1. Communications Protocols

Currently, multiple standard protocols could be considered for use by KM Servers. When deciding on a protocol for IP based communications, the protocol should be able to support both KMCS and KMSS communications in a way that both application and processor overhead are kept to a minimum.

Both TLS and IPSec are considered as potential protocols that can secure IP based communication. Both protocols are fairly well understood and have been inspected for flaws by cryptographic and protocol security experts. Both of these protocols can be adapted for use with the KMS. All other things being equal, we recommend using TLS because TLS use appears to outnumber IPSec use in many environments.

Establishment of a secure connection should require both session key negotiation and an authentication mechanism. Key negotiation is already built in to most standard secure communications protocols, but where it is not, IKEv2 may be an option.

2. Authentication Mechanisms

Authentication is a subject that needs to be addressed for both low-end KM Clients as well as KMS server-to-server communications. Authentication should be bi-directional, but there may be cases where the KM Client will need to authenticate with the KM Server and not have the KM Server authenticate to the cryptographic user.

Other KMS users may require user ID and password authentication and it is strongly recommended that two or more factor authentication be supported for KM Clients authenticating with KM Servers.

3. Messaging Format

Similar to communications protocols and authentication mechanisms, several message formats could be used for the KMS.

The two most common are ASN.1 and XML. Each has benefits that need to be explored to determine which would fit best in an overall service model. While it may be acceptable to use both or even another format, serious consideration should be given to supporting a single format in the first iteration of a KMS standard.

Identifying KM Clients and KM Servers: Delineation should be made between KM Servers and KM Clients. KM Clients normally include or control a CU that performs encryption and decryption of data at rest. KM Servers are software or hardware devices that provide services to KM Clients.

There is an option and a potential need in small to mid-size organizations to consolidate KMS operations (e.g., key storage into KM Clients). In these cases, when it is joined to a stand alone KM Server, the device should identify itself as a KM Client and be treated as such. This is specifically to help avoid conflicts that might need to be resolved by a centralized system such as when keys are disabled versus destroyed.

This is another reason that export/import functions may need to be automated so that when an intelligent KM Client attaches to a larger KM Realm, it can offload functions as needed and report to KMS services as would a normal KM Client.

Capability Negotiation: In order to ensure a KMS can add services or functions over time, a KM Server and KM Client should immediately negotiate which functions each supports upon initial connection. Capability negotiation means that a KMS and KM Client will decide which functions they can communicate to each other (key get, key store, key modify, key search, etc. . . . ) and what key metadata the KM Client will provide the KM Server.

This same type of negotiation should take place between two KM Servers when they first establish connection, to ensure that keys can be fully replicated from the originating KM Server to a second KM Server when required. These functions should be re-negotiated any time communications is interrupted for longer than a set amount of time or one of the devices has been upgraded. This allows a vendor to guarantee backward compatibility for at least one major version of any device's firmware.

Whenever possible, interoperability for a pre-defined set of functions should be maintained between updates in the standard specifically for compatibility. If changes are made that require compatibility to be forfeited, consideration should be given to allowing for a legacy mode of operation in the standards so that existing and new devices can be supported.

Special Considerations for Lightweight Clients: The minimum functions KM Clients need to support are to generate keys, store keys, and get keys. These functions provide a minimum interoperability level and methods of testing and certification. This does not preclude a KM Client from generating its own keys, and not requesting generated keys, since the KM Client initiates and controls the actions.

Another consideration for KM Client vendors is to include a mechanism for receiving a policy for enforcement of how encryption and keys are to be used.

Beyond these functions, KM Clients should be capable of negotiating what functions are supported in an expanded set of functions.

A number of embodiments of the technology have been described. Nevertheless, it will be understood that various modifications may be made without departing from the spirit and scope of the technology. Accordingly, other embodiments are within the scope of the following claims.

What is claimed is:

1. A method of controlling use of an encryption key, wherein the encryption key resides in one or more key management servers in a key management system, the method comprising:
disabling the encryption key, wherein the disabling comprises:
deleting the encryption key from all cryptographic units; and
isolating the encryption key within the key management servers in the key management system, wherein isolating the encryption key comprises barring all access to the disabled encryption key.

2. The method of claim 1, further comprising:
determining whether the encryption key can be returned to a usable state, wherein the determining is performed by a user with appropriate credentials; and
if the encryption key can be activated, activating the encryption key for use by the cryptographic units by restoring the key to a usable state.

3. The method of claim 2, wherein a user with appropriate credentials comprises a key administrator or manager.

4. The method of claim 2, wherein a usable state comprises any state higher than the disabled state.

5. The method of claim 2, wherein a user with appropriate credentials is authorized to determine whether a disabled key can be activated with respect to a security policy associated with the encryption key.

6. The method of claim 1, further comprising:
splitting the disabled key into two or more component shares, and
storing each component share, wherein rights to each component share are given to an administrator or manager, wherein no administrator or manager has rights to more than one component share.

7. The method of claim 6, further comprising:
determining whether the encryption key can be returned to a usable state, wherein the determining is performed by a user with appropriate credentials; and
restoring the encryption key to a usable state, wherein restoring the encryption key comprises restoring two or more of the component shares.

8. A method of identifying an object within a key management system, the method comprising:
creating a GUID for the object, wherein the GUID is represented by a URI, the URI comprising a prefix, a realm element, an object element, and a path element;
mapping the URI to one or more key management servers in the key management system; and
storing the object on the one or more key management servers in the key management system.

9. The method of claim 6, wherein the prefix is “km” or “kms”.

10. The method of claim 6, wherein the realm element comprises a name of a zone of authority within the key management system.

11. The method of claim 6, wherein the object element comprises an object space including any key under the control of the key management system.

12. The method of claim 11, wherein the object space is named one of “key”, “policy”, “client”, “group”, “pool”, “set”, “log”, “session”, or “.domain”.

13. The method of claim 6, wherein the object element comprises an object space including one of any key management policy, client, group, pool, set, log, or session.

14. The method of claim 6, wherein the object element comprises an object space reserved for the DNS domain.

15. The method of claim 6, wherein the path element comprises a multi-element path.

16. The method of claim 15, wherein the multi-element path defines a common default access control for the object.

17. The method of claim 6, wherein mapping comprises using KMSS or KMCS.

18. The method of claim 6, further comprising:
storing the object on one or more cryptographic units in the key management system.

19. The method of claim 6, further comprising:
storing the object on one or more KM Clients in the key management system.

20. The method of claim 6, further comprising:
distributing the object to one or more KM Clients in the key management system.

21. A method of retrieving an object within a key management system, the method comprising:
receiving a URI for the object;
mapping the URI to one or more key management servers in the key management system; and
retrieving the object from one of the one or more key management servers in the key management system.

22. The method of claim 21, wherein mapping comprises using KMSS or KMCS.
